(19) United States
(12) Patent Application Publication
(10) Pub. No.: US 2026/0164047 A1
(43) Pub. Date: Jun. 11, 2026

(54) METHOD, APPARATUS, AND MEDIUM FOR VIDEO PROCESSING

(71) Applicant: Bytedance Inc., Los Angeles, CA (US)

(72) Inventors: Yue Li, Los Angeles, CA (US); Kai Zhang, Los Angeles, CA (US); Li Zhang, Los Angeles, CA (US)

(21) Appl. No.: 19/178,662

(22) Filed: Apr. 14, 2025

Related U.S. Application Data
(63) Continuation of application No. PCT/US2023/076823, filed on Oct. 13, 2023.
(60) Provisional application No. 63/416,130, filed on Oct. 14, 2022.

(51) Int. Cl. H04N 19/436; G06N 3/0464; H04N 19/176; H04N 19/70

(52) U.S. Cl. CPC H04N 19/436; G06N 3/0464; H04N 19/176; H04N 19/70

(57) ABSTRACT

Embodiments of the present disclosure provide a solution for video processing. A method for video processing is proposed. The method comprises: obtaining a neural network (NN) model for processing a video, the NN model comprising at least one basic block, wherein a basic block comprises: a plurality of branches for parallel processing an input of the basic block, a branch comprising at least one convolutional layer and at least one activation layer, and a plurality of layers for serial processing a combination of outputs of the plurality of branch, the plurality of layers comprising at least one convolutional layer and at least one activation layer; and performing, according to the NN model, a conversion between a current video block of the video and a bitstream of the video.

### CROSS REFERENCE TO RELATED APPLICATIONS

This application is a continuation of International Application No. PCT/US2023/076823, filed on Oct. 13, 2023, which claims the benefit of U.S. Provisional Application No. 63/416,130, filed on Oct. 14, 2022. The entire contents of these applications are hereby incorporated by reference in their entireties.

### FIELDS

Embodiments of the present disclosure relates generally to video processing techniques, and more particularly, to neural network architectures for video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for neural network architectures for video coding.

In a first aspect, a method for video processing is proposed. The method comprises: obtaining a neural network (NN) model for processing a video, the NN model comprising at least one basic block, wherein a basic block comprises: a plurality of branches for parallel processing an input of the basic block, a branch comprising at least one convolutional layer and at least one activation layer, and a plurality of layers for serial processing a combination of outputs of the plurality of branch, the plurality of layers comprising at least one convolutional layer and at least one activation layer; and performing, according to the NN model, a conversion between a current video block of the video and a bitstream of the video. The method in accordance with the first aspect of the present disclosure provides efficient network architectures for vide coding, which can improve the performance-complexity trade-off. In this way, coding performance can be further improved.

In a second aspect, an apparatus for processing video data is proposed. The apparatus for processing video data comprises a processor and a non-transitory memory with instructions thereon, wherein the instructions upon execution by the processor, cause the processor to perform a method in accordance with the first aspect.

In a third aspect, a non-transitory computer-readable storage medium is proposed. The non-transitory computer-readable storage medium storing instructions that cause a processor to perform a method in accordance with the first aspect.

In a fourth aspect, a non-transitory computer-readable recording medium is proposed. The non-transitory computer-readable recording medium stories a bitstream of a video which is generated by a method performed by a video processing apparatus. The method comprises: obtaining a neural network (NN) model for processing a video, the NN model comprising at least one basic block, wherein a basic block comprises: a plurality of branches for parallel processing an input of the basic block, a branch comprising at least one convolutional layer and at least one activation layer, and a plurality of layers for serial processing a combination of outputs of the plurality of branch, the plurality of layers comprising at least one convolutional layer and at least one activation layer; and generating a bitstream of the video according to the NN model.

In a fifth aspect, a method for storing bitstream of a video is proposed. The method comprises: obtaining a neural network (NN) model for processing a video, the NN model comprising at least one basic block, wherein a basic block comprises: a plurality of branches for parallel processing an input of the basic block, a branch comprising at least one convolutional layer and at least one activation layer, and a plurality of layers for serial processing a combination of outputs of the plurality of branch, the plurality of layers comprising at least one convolutional layer and at least one activation layer; generating a bitstream of the video according to the NN model; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example of raster-scan slice partitioning of a picture;

FIG. 5 illustrates an example of rectangular slice partitioning of a picture;

FIG. 6 illustrates an example of a picture partitioned into tiles, bricks, and rectangular slices;

FIG. 7A illustrates a schematic diagram of coding tree blocks (CTBs) crossing the bottom picture border;

FIG. 7B illustrates a schematic diagram of CTBs crossing the right picture border;

FIG. 7C illustrates a schematic diagram of CTBs crossing the right bottom picture border;

FIG. 8 illustrates an example of encoder block diagram of VVC;

FIG. 9 illustrates a schematic diagram of picture samples and horizontal and vertical block boundaries on the 8×8 grid, and the nonoverlapping blocks of the 8×8 samples, which can be deblocked in parallel;

FIG. 10 illustrates a schematic diagram of pixels involved in filter on/off decision and strong/weak filter selection;

FIG. 11A illustrates an example of 1-D directional pattern for EO sample classification which is a horizontal pattern with EO class=0;

FIG. 11B illustrates an example of 1-D directional pattern for EO sample classification which is a vertical pattern with EO class=1;

FIG. 11C illustrates an example of 1-D directional pattern for EO sample classification which is a 1350 diagonal pattern with EO class=2;

FIG. 11D illustrates an example of 1-D directional pattern for EO sample classification which is a 450 diagonal pattern with EO class=3;

FIG. 12A illustrates an example of a geometry transformation-based adaptive loop filter (GALF) filter shape of 5×5 diamond;

FIG. 12B illustrates an example of a GALF filter shape of 7×7 diamond;

FIG. 12C illustrates an example of a GALF filter shape of 9×9 diamond;

FIG. 13A illustrates an example of relative coordinator for the 5×5 diamond filter support in case of diagonal;

FIG. 13B illustrates an example of relative coordinator for the 5×5 diamond filter support in case of vertical flip;

FIG. 13C illustrates an example of relative coordinator for the 5×5 diamond filter support in case of rotation;

FIG. 14 illustrates an example of relative coordinates used for 5×5 diamond filter support;

FIG. 15A illustrates a schematic diagram of an architecture of a typically used convolutional neural network (CNN) where M denotes the number of feature maps and N stands for the number of samples in one dimension;

FIG. 15B illustrates an example of the construction of residual block (ResBlock) in the CNN filter of FIG. 15A;

FIG. 16A illustrates a schematic diagram of an architecture of a basic block of a first type (Type A) contained in NN models in accordance with some embodiments of the present disclosure;

FIG. 16B illustrates a schematic diagram of an architecture of a basic block of a second type (Type B) contained in NN models in accordance with some embodiments of the present disclosure;

FIG. 17 illustrates a schematic diagram of an architecture of a NN model comprising three parts in accordance with some embodiments of the present disclosure;

FIG. 18 illustrates a schematic diagram of a stack of basic blocks, where BasicBlockTypeA is the block shown in FIG. 16A in accordance with some embodiments of the present disclosure;

FIG. 19 illustrates a schematic diagram of a stack of basic blocks, where BasicBlockTypeB is the block shown in FIG. 16B in accordance with some further embodiments of the present disclosure;

FIG. 20 illustrates a schematic diagram of a stack of basic blocks, where BasicBlockTypeA is the block shown in FIG. 16A and BasicBlockTypeB is the block shown in FIG. 16B in accordance with some yet further embodiments of the present disclosure;

FIG. 21 illustrates a schematic diagram of a stack of basic blocks, where BasicBlockTypeB is the block shown in FIG. 16B and BasicBlockTypeA is the block shown in FIG. 16A in accordance with some yet further embodiments of the present disclosure;

FIG. 22A illustrates a schematic diagram of an architecture of a vanilla residual block in accordance with some embodiments of the present disclosure;

FIG. 22B illustrates a schematic diagram of an architecture of a wide residual block in accordance with some embodiments of the present disclosure where M>K;

FIG. 23 illustrates a schematic diagram of an architecture of the proposed deep in-loop filter in accordance with some embodiments of the present disclosure;

FIG. 24 illustrates a flowchart of a method for video processing in accordance with embodiments of the present disclosure;

FIG. 25 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

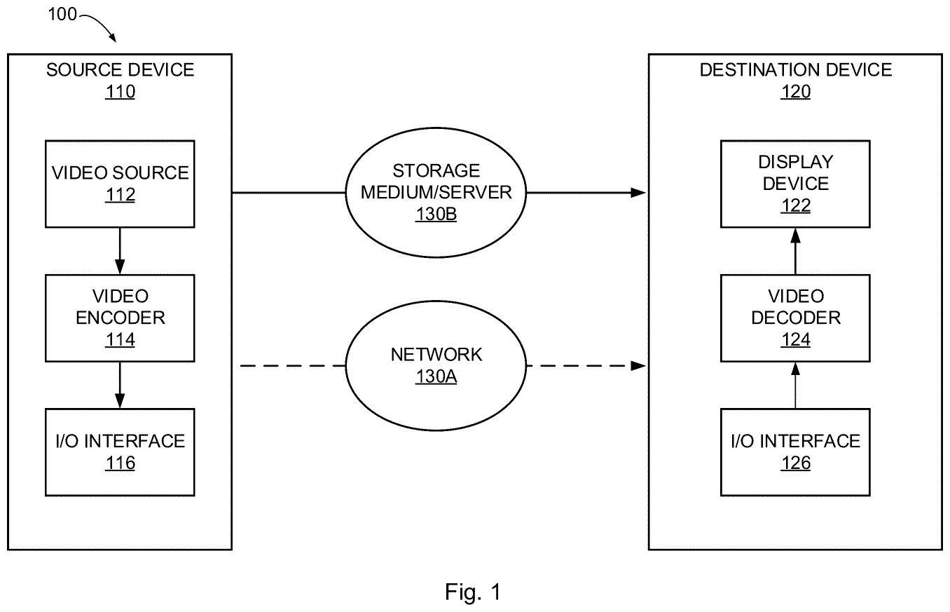

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

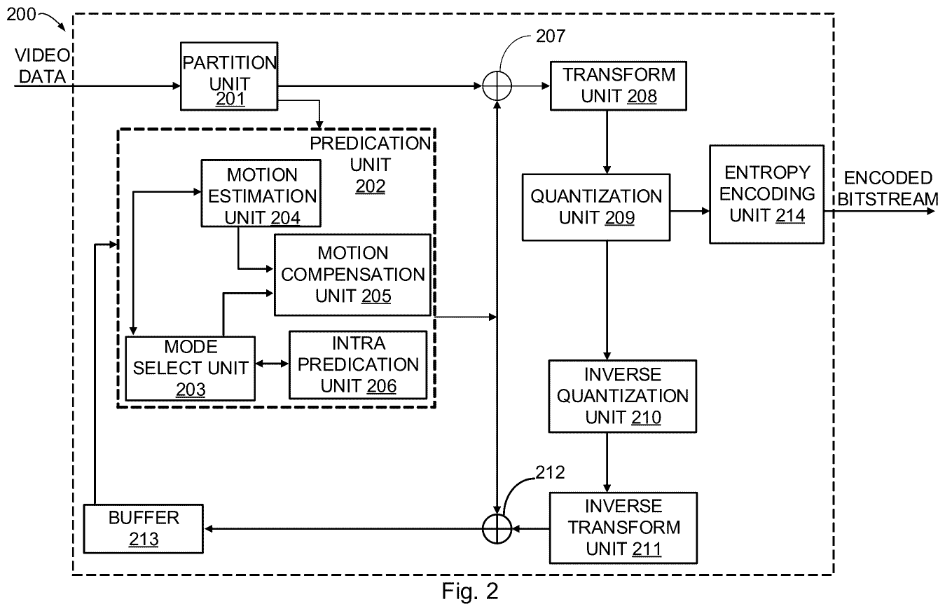

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

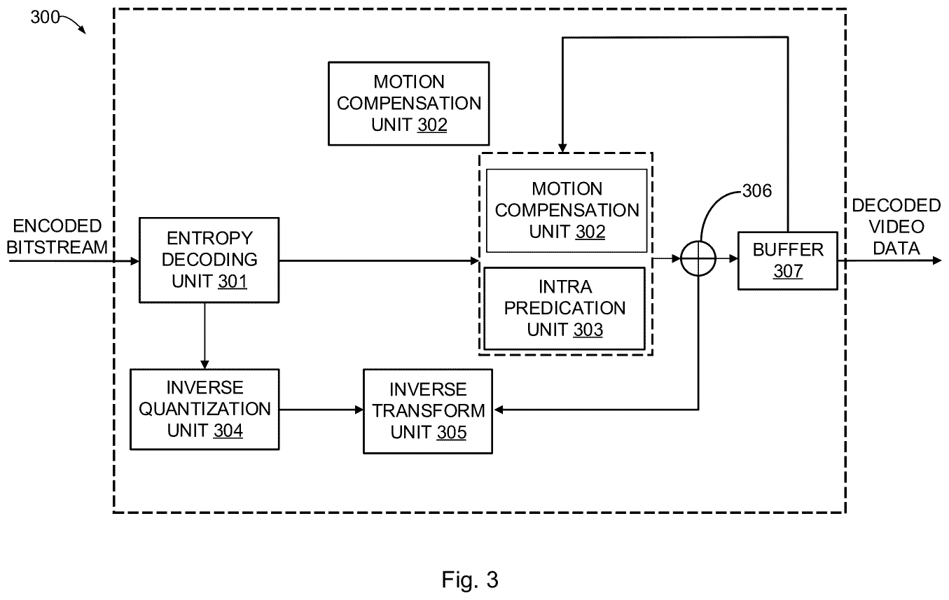

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. SUMMARY

The detailed description is related to video coding technologies. Specifically, it is related to the loop filter in image/video coding. It may be applied to the existing video coding standard like High-Efficiency Video Coding (HEVC), Versatile Video Coding (VVC), or the standard (e.g., AVS3) to be finalized. It may be also applicable to future video coding standards or video codec or being used as post-processing method which is out of encoding/decoding process.

### 2. BACKGROUND

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC. VVC version 1 was finalized in July 2020.

### 2.1. Color Space and Chroma Subsampling

Color space, also known as the color model (or color system), is an abstract mathematical model which simply describes the range of colors as tuples of numbers, typically as 3 or 4 values or color components (e.g. RGB).

Basically speaking, color space is an elaboration of the coordinate system and sub-space.

For video compression, the most frequently used color spaces are YCbCr and RGB.

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

### 2.1.1. 4:4:4

Each of the three Y′CbCr components have the same sample rate, thus there is no chroma subsampling. This scheme is sometimes used in high-end film scanners and cinematic post production.

### 2.1.2. 4:2:2

The two chroma components are sampled at half the sample rate of luma: the horizontal chroma resolution is halved. This reduces the bandwidth of an uncompressed video signal by one-third with little to no visual difference

### 2.1.3. 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.
In MPEG-2, Cb and Cr are cosited horizontally. Cb and Cr are sited between pixels in the vertical direction (sited interstitially).
In JPEG/JFIF, H.261, and MPEG-1, Cb and Cr are sited interstitially, halfway between alternate luma samples.
In 4:2:0 DV, Cb and Cr are co-sited in the horizontal direction. In the vertical direction, they are co-sited on alternating lines.

### 2.2. Definitions of Video Units

A picture is divided into one or more tile rows and one or more tile columns. A tile is a sequence of CTUs that covers a rectangular region of a picture.

A tile is divided into one or more bricks, each of which consisting of a number of CTU rows within the tile.

A tile that is not partitioned into multiple bricks is also referred to as a brick. However, a brick that is a true subset of a tile is not referred to as a tile.

A slice either contains a number of tiles of a picture or a number of bricks of a tile.

Two modes of slices are supported, namely the raster-scan slice mode and the rectangular slice mode. In the raster-scan slice mode, a slice contains a sequence of tiles in a tile raster scan of a picture. In the rectangular slice mode, a slice contains a number of bricks of a picture that collectively form a rectangular region of the picture. The bricks within a rectangular slice are in the order of brick raster scan of the slice.

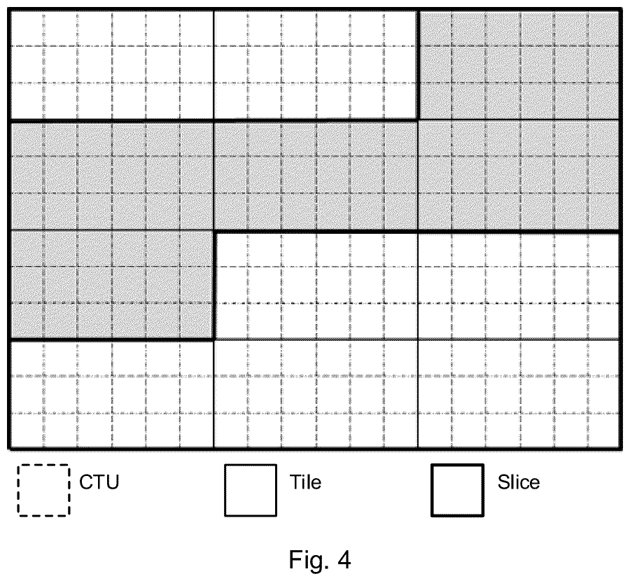

FIG. 4 shows an example of raster-scan slice partitioning of a picture, where the picture is divided into 12 tiles and 3 raster-scan slices. In this figure, a picture with 18 by 12 luma CTUs is partitioned into 12 tiles and 3 raster-scan slices (informative).

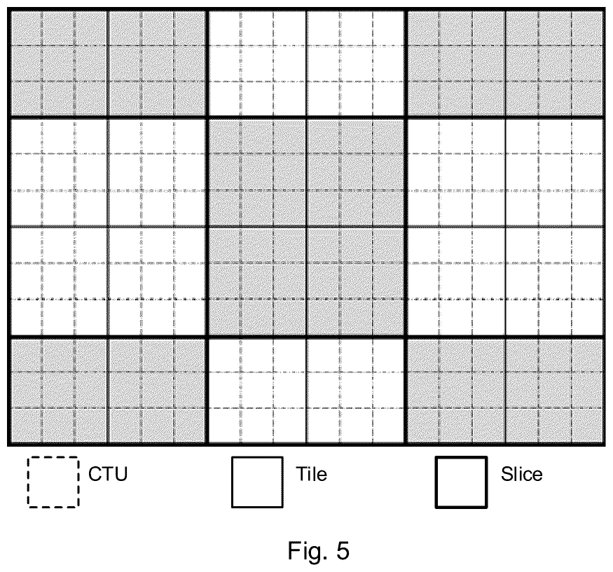

FIG. 5 in the VVC specification shows an example of rectangular slice partitioning of a picture, where the picture is divided into 24 tiles (6 tile columns and 4 tile rows) and 9 rectangular slices. In this figure, a picture with 18 by 12 luma CTUs is partitioned into 24 tiles and 9 rectangular slices (informative).

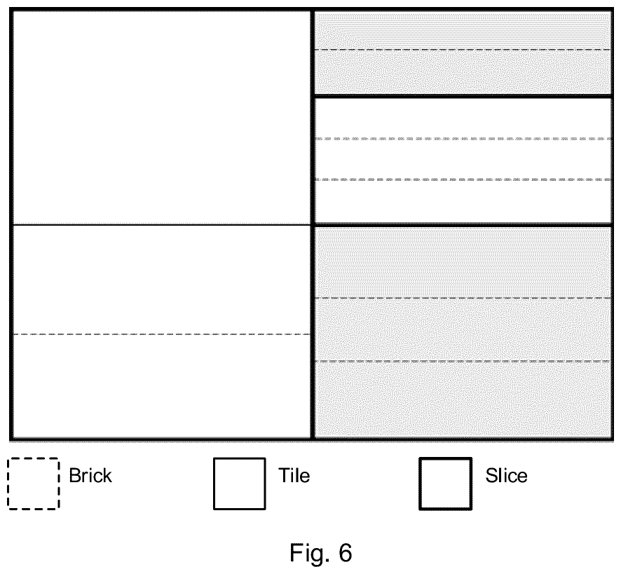

FIG. 6 in the VVC specification shows an example of a picture partitioned into tiles, bricks, and rectangular slices, where the picture is divided into 4 tiles (2 tile columns and 2 tile rows), 11 bricks (the top-left tile contains 1 brick, the top-right tile contains 5 bricks, the bottom-left tile contains 2 bricks, and the bottom-right tile contain 3 bricks), and 4 rectangular slices. In this figure, a picture that is partitioned into 4 tiles, 11 bricks, and 4 rectangular slices (informative)

### 2.2.1. CTU/CTB Sizes

In VVC, the CTU size, signaled in SPS by the syntax element log 2_ctu_size_minus2, could be as small as 4×4.

### 7.3.2.3 Sequence Parameter Set RBSP Syntax

| | Descriptor |
|---|---|
| seq_parameter_set_rbsp( ) { | |
| sps_decoding_parameter_set_id | u(4) |
| sps_video_parameter_set_id | u(4) |
| sps_max_sub_layers_minus1 | u(3) |
| sps_reserved_zero_5bits | u(5) |
| profile_tier_level( sps_max_sub_layers_minus1 ) | |
| gra_enabled_flag | u(1) |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| long_term_ref_pics_flag | u(1) |
| sps_idr_rpl_present_flag | u(1) |
| rpl1_same_as_rpl0_flag | u(1) |
| for( i = 0; i < !rpl1_same_as_rpl0_flag ? 2 : 1; i++ ) { | |
| num_ref_pic_lists_in_sps[ i ] | ue(v) |
| for( j = 0; j < num_ref_pic_lists_in_sps[ i ]; j++) | |
| ref_pic_list_struct( i, j ) | |
| } | |
| qtbtt_dual_tree_intra_flag | u(1) |
| log2_ctu_size_minus2 | ue(v) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slices != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if ( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| ... | |
| rbsp_trailing_bits( ) | |
| } | |

log 2_ctu_size_minus2 plus 2 specifies the luma coding tree block size of each CTU.

log 2_min_luma_coding_block_size_minus2 plus 2 specifies the minimum luma coding block size.

The variables CtbLog2SizeY, CtbSizeY, MinCbLog2SizeY, MinCbSizeY, MinTbLog2SizeY, MaxThLog2SizeY, MinTbSizeY, MaxThSizeY, PicWidthlnCtbsY, PicHeightlnCtbsY, PicSizelnCtbsY, PicWidthInMinCbsY, PicHeightInMinCbsY, PicSizeInMinCbsY, PicSizeInSamplesY, PicWidthInSamplesC and PicHeightInSamplesC are derived as follows:

$$CtbLog 2 SizeY = log 2 \_ctu \_size \_minus 2 + 2 \qquad ( 7 - 9 )$$

$$CtbSizeY = 1 ≪ CtbLog 2 SizeY \qquad ( 7 - 10 )$$

$$MinCbLog 2 SizeY = log 2 \_min \_luma \_coding \_block \_size \_minus 2 + 2 \qquad ( 7 - 11 )$$

$$MinCbSizeY = 1 ≪ MinCbLog 2 SizeY \qquad ( 7 - 12 )$$

$$MinTbLog 2 SizeY = 2 \qquad ( 7 - 13 )$$

$$MaxTbLog 2 SizeY = 6 \qquad ( 7 - 14 )$$

$$MinTbSizeY = 1 ≪ MinTbLog 2 SizeY \qquad ( 7 - 15 )$$

$$MaxTbSizeY = 1 ≪ MaxTbLog 2 SizeY \qquad ( 7 - 16 )$$

$$PicWidthInCtbsY = Ceil ( pic\_width \_in \_luma \_sample \div CtbSizeY ) \qquad ( 7 - 17 )$$

$$PicHeightInCtbsY = Ceil ( pic\_height \_in \_luma \_sample \div CtbSizeY ) \qquad ( 7 - 18 )$$

$$PicSizeInCtbsY = PicWidthinCtbsY * PicHeightInCtbsY \qquad ( 7 - 19 )$$

$$PicWidthInMinCbsY = pic\_width \_in \_luma \_samples / MinCbSizeY \qquad ( 7 - 20 )$$

$$PicHeightInMinCbsY = pic\_height \_in \_luma \_samples / MinCbSizeY \qquad ( 7 - 21 )$$

$$PicSizeInMinCbsY = PicWidthInMinCbsY * PicHeightInMinCbsY \qquad ( 7 - 22 )$$

$$PicSizeInSamplesY = pic\_width \_in \_luma \_samples * pic\_height \_in \_luma \_samples \qquad ( 7 - 23 )$$

$$PicWidthInSamplesC = pic\_width \_in \_luma \_samples / SubWidthC \qquad ( 7 - 24 )$$

$$PicHeightInSamplesC = pic\_height \_in \_luma \_samples / SubHeightC \qquad ( 7 - 25 )$$

### 2.2.2. CTUs in a Picture

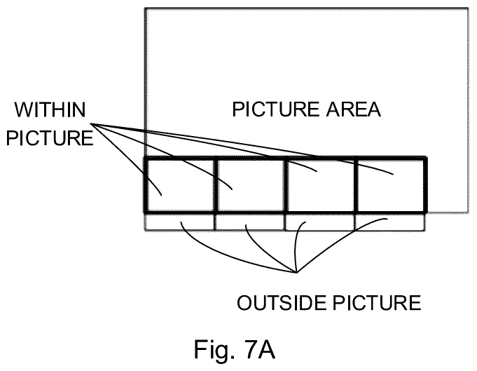

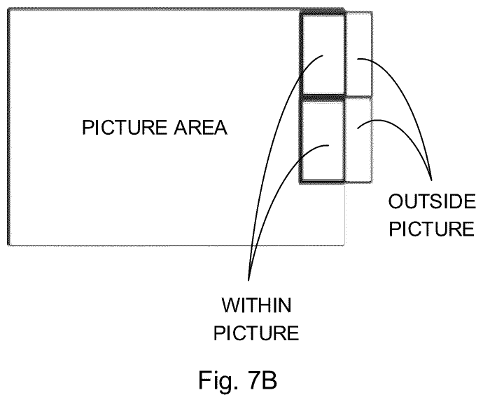

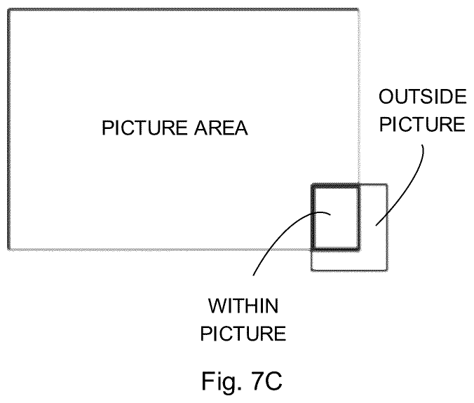

Suppose the CTB/LCU size indicated by M×N (typically M is equal to N, as defined in HEVC/VVC), and for a CTB located at picture (or tile or slice or other kinds of types, picture border is taken as an example) border, K×L samples are within picture border wherein either K<M or L<N. For those CTBs as depicted in FIGS. 7A, 7B, and 7C, the CTB size is still equal to M×N, however, the bottom boundary/right boundary of the CTB is outside the picture.

FIGS. 7A, 7B, and 7C shows examples of CTBs crossing picture borders. FIG. 7A shows CTBs crossing the bottom picture border, where K=M, L<N. FIG. 7B shows CTBs crossing the right picture border, where K<M, L=N. FIG. 7C shows CTBs crossing the right bottom picture border where K<M, L<N.

### 2.3. Coding Flow of a Typical Video Codec

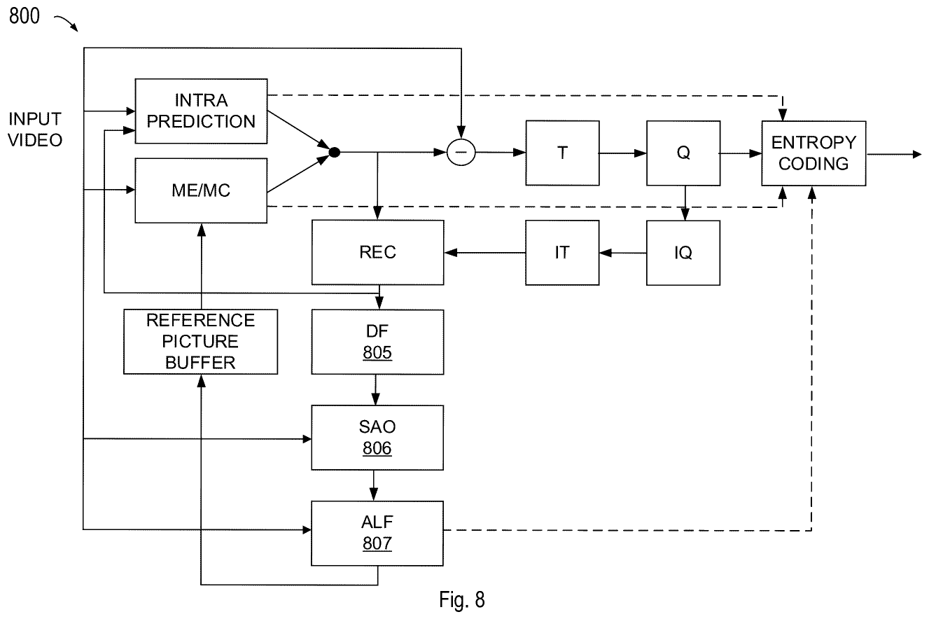

FIG. 5 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signaling the offsets and filter coefficients. ALF is located at the last processing stage of each picture and can be regarded as a tool trying to catch and fix artifacts created by the previous stages. FIG. 8 shows an example 800 of encoder block diagram.

### 2.4. Deblocking Filter (DB)

The input of DB is the reconstructed samples before in-loop filters.

The vertical edges in a picture are filtered first. Then the horizontal edges in a picture are filtered with samples modified by the vertical edge filtering process as input. The vertical and horizontal edges in the CTBs of each CTU are processed separately on a coding unit basis. The vertical edges of the coding blocks in a coding unit are filtered starting with the edge on the left-hand side of the coding blocks proceeding through the edges towards the right-hand side of the coding blocks in their geometrical order. The horizontal edges of the coding blocks in a coding unit are filtered starting with the edge on the top of the coding blocks proceeding through the edges towards the bottom of the coding blocks in their geometrical order.

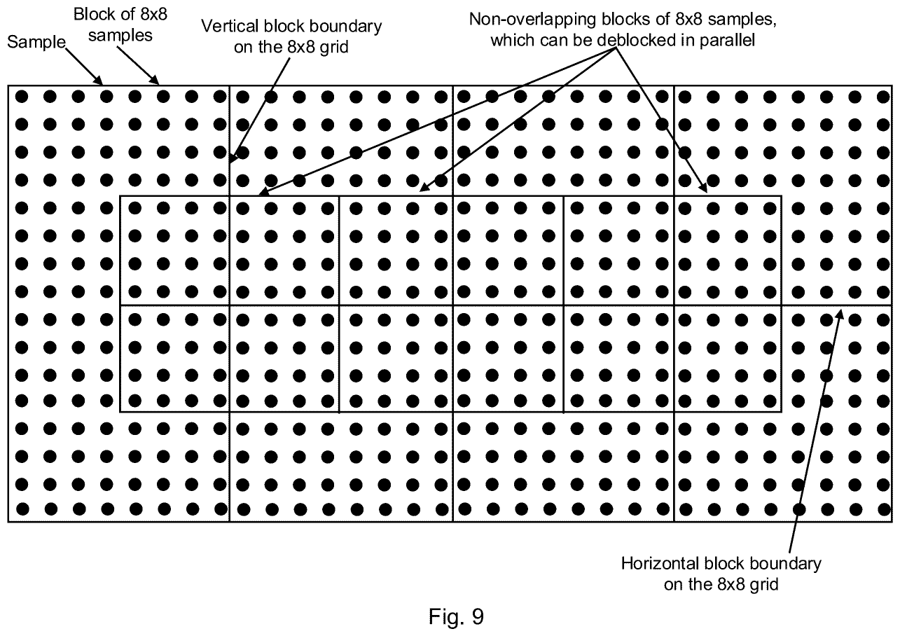

FIG. 9 provides illustration of picture samples and horizontal and vertical block boundaries on the 8×8 grid, and the nonoverlapping blocks of the 8×8 samples, which can be deblocked in parallel.

### 2.4.1. Boundary Decision

Filtering is applied to 8×8 block boundaries. In addition, it must be a transform block boundary or a coding subblock boundary (e.g., due to usage of Affine motion prediction, ATMVP). For those which are not such boundaries, filter is disabled.

### 2.4.2. Boundary Strength Calculation

For a transform block boundary/coding subblock boundary, if it is located in the 8×8 grid, it may be filtered and the setting of bS[xDᵢ][yDⱼ] (wherein [xDᵢ][yDⱼ] denotes the coordinate) for this edge is defined in Table 1 and Table 2, respectively.

TABLE 1
Boundary strength (when SPS IBC is disabled)

| Priority | Conditions | Y | U | V |
|---|---|---|---|---|
| 5 | At least one of the adjacent blocks is intra | 2 | 2 | 2 |
| 4 | TU boundary and at least one of the adjacent | 1 | 1 | 1 |
| | blocks has non-zero transform coefficients | | | |
| 3 | Reference pictures or number of MVs (1 for | 1 | N/A | N/A |
| | uni-prediction, 2 for bi-prediction) of the | | | |
| | adjacent blocks are different | | | |
| 2 | Absolute difference between the motion | 1 | N/A | N/A |
| | vectors of same reference picture that | | | |
| | belong to the adjacent blocks is greater | | | |
| | than or equal to one integer luma sample | | | |
| 1 | Otherwise | 0 | 0 | 0 |

TABLE 2
Boundary strength (when SPS IBC is enabled)

| Priority | Conditions | Y | U | V |
|---|---|---|---|---|
| 8 | At least one of the adjacent blocks is intra | 2 | 2 | 2 |
| 7 | TU boundary and at least one of the adjacent | 1 | 1 | 1 |
| | blocks has non-zero transform coefficients | | | |
| 6 | Prediction mode of adjacent blocks is | 1 | | |
| | different (e.g., one is IBC, one is inter) | | | |
| 5 | Both IBC and absolute difference between | 1 | N/A | N/A |
| | the motion vectors that belong to the | | | |
| | adjacent blocks is greater than or equal to | | | |
| | one integer luma sample | | | |
| 4 | Reference pictures or number of MVs (1 | 1 | N/A | N/A |
| | for uni-prediction, 2 for bi-prediction) of | | | |
| | the adjacent blocks are different | | | |
| 3 | Absolute difference between the motion | 1 | N/A | N/A |
| | vectors of same reference picture that | | | |
| | belong to the adjacent blocks is greater | | | |
| | than or equal to one integer luma sample | | | |
| 1 | Otherwise | 0 | 0 | 0 |

### 2.4.3. Deblocking Decision for Luma Component

The deblocking decision process is described in this sub-section.

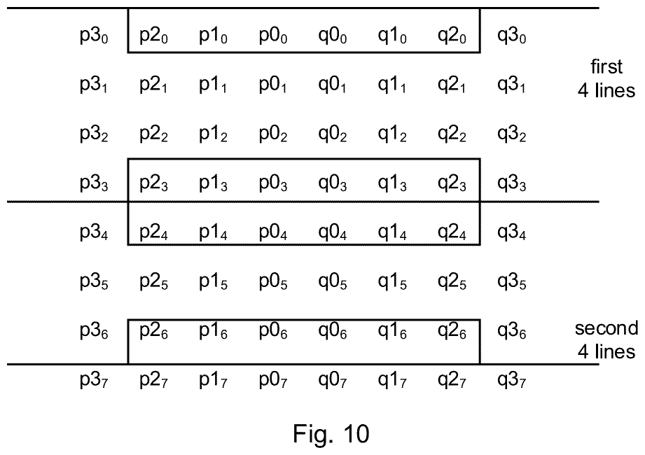

FIG. 10 shows pixels involved in filter on/off decision and strong/weak filter selection.

Wider-stronger luma filter is filters are used only if all the Condition1, Condition2 and Condition 3 are TRUE.

The condition 1 is the “large block condition”. This condition detects whether the samples at P-side and Q-side belong to large blocks, which are represented by the variable bSidePisLargeBlk and bSideQisLargeBlk respectively. The bSidePisLargeBlk and bSideQisLargeBlk are defined as follows.

bSidePisLargeBlk=((edge type is vertical and p₀ belongs to CU with width>=32)∥(edge type is horizontal and p₀ belongs to CU with height>=32))?TRUE:FALSE

bSideQisLargeBlk=((edge type is vertical and q₀ belongs to CU with width>=32)∥(edge type is horizontal and q₀ belongs to CU with height>=32))?TRUE:FALSE

Based on bSidePisLargeBlk and bSideQisLargeBlk, the condition 1 is defined as follows.

Condition1=(bSidePisLargeBlk∥bSidePisLargeBlk)?TRUE:FALSE

Next, if Condition 1 is true, the condition 2 will be further checked. First, the following variables are derived:
dp0, dp3, dq0, dq3 are first derived as in HEVC
if (p side is greater than or equal to 32)

$$\begin{matrix}dp 0 = ( dp 0 + Abs ( p {5}_{0} - {2}^{*} p {4}_{0} + p {3}_{0} ) + 1 ) ≫ 1 \\ dp 3 = ( dp 3 + Abs ( p {5}_{3} - {2}^{*} p {4}_{3} + p {3}_{3} ) + 1 ) ≫ 1\end{matrix}$$

if (q side is greater than or equal to 32)

$$\begin{matrix}dq 0 = ( dq 0 + Abs ( q {5}_{0} - 2 * q {4}_{0} + q {3}_{0} ) + 1 ) ≫ 1 \\ dq 3 = ( dq 3 + Abs ( q {5}_{3} - {2}^{*} q {4}_{3} + q {3}_{3} ) + 1 ) ≫ 1\end{matrix}$$

Condition2=(d<β)?TRUE:FALSE

$$where d = dp 0 + dp 0 + dp 3 + dp 3.$$

If Condition1 and Condition2 are valid, whether any of the blocks uses sub-blocks is further checked:
If (bSidePisLargeBlk)

```
  {
      If (mode block P == SUBBLOCKMODE)
            Sp =5
        else
            Sp =7
}
else
  Sp = 3
If (bSideQisLargeBlk)
    {
      If (mode block Q == SUBBLOCKMODE)
              Sq =5
          else
          Sq =7
    }
else
    Sq = 3
```

Finally, if both the Condition 1 and Condition 2 are valid, the proposed deblocking method will check the condition 3 (the large block strong filter condition), which is defined as follows.

In the Condition3 StrongFilterCondition, the following variables are derived:

```
  dpq is derived as in HEVC.
  sp₃ = Abs( p₃ − p₀ ), derived as in HEVC
  if (p side is greater than or equal to 32)
      if(Sp==5)
        sp₃ = ( sp₃ + Abs( p₅ − p₃ ) + 1) >> 1
      else
        sp₃ = ( sp₃ + Abs( p₇ − p₃ ) + 1) >> 1
  sq₃ = Abs( q₀ − q₃ ), derived as in HEVC
  if (q side is greater than or equal to 32)
    If(Sq==5)
      sq₃ = ( sq₃ + Abs( q₅ − q₃ ) + 1) >> 1
    else
      sq₃ = ( sq₃ + Abs( q₇ − q₃ ) + 1) >> 1
As in HEVC, StrongFilterCondition = (dpq is less than ( β >> 2 ), sp₃ +
sq₃ is less than ( 3*β >> 5 ), and
Abs( p₀ − q₀ ) is less than ( 5 * t_{C} + 1 ) >> 1) ? TRUE : FALSE.
```

### 2.4.4. Stronger Deblocking Filter for Luma (Designed for Larger Blocks)

Bilinear filter is used when samples at either one side of a boundary belong to a large block. A sample belonging to a large block is defined as when the width>=32 for a vertical edge, and when height>=32 for a horizontal edge.

The bilinear filter is listed below.

Block boundary samples pi for i=0 to Sp−1 and qi for j=0 to Sq−1 (pi and qi are the i-th sample within a row for filtering vertical edge, or the i-th sample within a column for filtering horizontal edge) in HEVC deblocking described above) are then replaced by linear interpolation as follows:

$$\begin{matrix}– {p}_{i}^{′} = ( {f}_{i} * {Middle}_{s , t} + ( 64 - {f}_{i} ) * {P}_{s} + 32 ) ≫ 6 ) , clipped to {p}_{i} \pm {tcPD}_{i} \\ – {q}_{j}^{′} = ( {g}_{j} * {Middle}_{s , t} + ( 64 - {g}_{j} ) * {Q}_{s} + 32 ) ≫ 6 ) , clipped to {p}_{j} \pm {tcPD}_{j}\end{matrix}$$

where tcPDᵢ and tcPDⱼ term is a position dependent clipping described in Section 2.4.7 and gⱼ, fᵢ, Middle_{s,t}, Pₛ and Qₛ are given below.

### 2.4.5. Deblocking Control for Chroma

The chroma strong filters are used on both sides of the block boundary. Here, the chroma filter is selected when both sides of the chroma edge are greater than or equal to 8 (chroma position), and the following decision with three conditions are satisfied: the first one is for decision of boundary strength as well as large block. The proposed filter can be applied when the block width or height which orthogonally crosses the block edge is equal to or larger than 8 in chroma sample domain. The second and third one is basically the same as for HEVC luma deblocking decision, which are on/off decision and strong filter decision, respectively.

In the first decision, boundary strength (bS) is modified for chroma filtering and the conditions are checked sequentially. If a condition is satisfied, then the remaining conditions with lower priorities are skipped.

Chroma deblocking is performed when bS is equal to 2, or bS is equal to 1 when a large block boundary is detected.

The second and third condition is basically the same as HEVC luma strong filter decision as follows.

In the second condition:
d is then derived as in HEVC luma deblocking.
The second condition will be TRUE when d is less than D.

In the third condition StrongFilterCondition is derived as follows:
dpq is derived as in HEVC.

$$\begin{matrix}{sp}_{3} = Abs ( {p}_{3} - {p}_{0} ) , derived as in HEVC \\ {sp}_{3} = Abs ( {q}_{0} - {q}_{3} ) , derived as in HEVC\end{matrix}$$

As in HEVC design, StrongFilterCondition=(dpq is less than (β>>2), sp₃+sq₃ is less than (β>>3), and Abs(p₀−q₀) is less than (5*t_{C}+1)>>1).

### 2.4.6. Strong Deblocking Filter for Chroma

The following strong deblocking filter for chroma is defined:

$$\begin{matrix}{p}_{2}^{′} = ( 3 * {p}_{3} + 2 * {p}_{2} + {p}_{1} + {p}_{0} + {q}_{0} + 4 ) ≫ 3 \\ {p}_{1}^{′} = ( 2 * {p}_{3} + {p}_{2} + {2}^{*} {p}_{1} + {p}_{0} + {q}_{0} + {q}_{1} + 4 ) ≫ 3 \\ {p}_{0}^{′} = ( {p}_{3} + {p}_{2} + {p}_{1} + 2 * {p}_{0} + {q}_{0} + {q}_{1} + {q}_{2} + 4 ) ≫ 3\end{matrix}$$

The proposed chroma filter performs deblocking on a 4×4 chroma sample grid.

### 2.4.7. Position Dependent Clipping

The position dependent clipping tcPD is applied to the output samples of the luma filtering process involving strong and long filters that are modifying 7, 5 and 3 samples at the boundary. Assuming quantization error distribution, it is proposed to increase clipping value for samples which are expected to have higher quantization noise, thus expected to have higher deviation of the reconstructed sample value from the true sample value.

For each P or Q boundary filtered with asymmetrical filter, depending on the result of decision-making process in section 2.4.2, position dependent threshold table is selected from two tables (i.e., Tc7 and Tc3 tabulated below) that are provided to decoder as a side information:

$$\begin{matrix}Tc 7 = \{ 6 , 5 , 4 , 3 , 2 , 1 , 1 \} ; Tc 3 = \{ 6 , 4 , 2 \} ; \\ tcPD = ( Sp == 3 ) ? Tc 3 : Tc 7 ; \\ tcQD = ( Sq == 3 ) ? Tc 3 : Tc 7 ;\end{matrix}$$

For the P or Q boundaries being filtered with a short symmetrical filter, position dependent threshold of lower magnitude is applied:

$$Tc 3 = \{ 3 , 2 , 1 \} ;$$

Following defining the threshold, filtered p′ᵢ and q′ᵢ sample values are clipped according to tcP and tcQ clipping values:

$$\begin{matrix}{p}_{i}^{″} = Clip 3 ( {p}_{i}^{′} + tc {P}_{i} , {p}_{i}^{′} - {tcP}_{i} , {p}_{i}^{′} ) ; \\ {q}_{j}^{″} = Clip 3 ( {q}_{j}^{′} + {tcQ}_{j} , {q}_{j}^{′} - {tcQ}_{j} , {q}_{j}^{′} ) ;\end{matrix}$$

where p′ᵢ and q′ᵢ are filtered sample values, p″ᵢ and q″ⱼ are output sample value after the clipping and tcPᵢ tcPᵢ are clipping thresholds that are derived from the VVC tc parameter and tcPD and tcQD. The function Clip3 is a clipping function as it is specified in VVC.

### 2.4.8. Sub-Block Deblocking Adjustment

To enable parallel friendly deblocking using both long filters and sub-block deblocking the long filters is restricted to modify at most 5 samples on a side that uses sub-block deblocking (AFFINE or ATMVP or DMVR) as shown in the luma control for long filters. Additionally, the sub-block deblocking is adjusted such that that sub-block boundaries on an 8×8 grid that are close to a CU or an implicit TU boundary is restricted to modify at most two samples on each side.

Following applies to sub-block boundaries that not are aligned with the CU boundary.

```
If (mode block Q == SUBBLOCKMODE && edge !=0) {
  if (!(implicitTU && (edge == (64 / 4))))
    if (edge == 2 ∥ edge == (orthogonalLength − 2) ∥ edge == (56 / 4) ∥ edge == (72 / 4))
        Sp = Sq = 2;
      else
        Sp = Sq = 3;
  else
      Sp = Sq = bSideQisLargeBlk ? 5:3
}
```

Where edge equal to 0 corresponds to CU boundary, edge equal to 2 or equal to orthogonalLength-2 corresponds to sub-block boundary 8 samples from a CU boundary etc. Where implicit TU is true if implicit split of TU is used.

### 2.5. SAO

The input of SAO is the reconstructed samples after DB. The concept of SAO is to reduce mean sample distortion of a region by first classifying the region samples into multiple categories with a selected classifier, obtaining an offset for each category, and then adding the offset to each sample of the category, where the classifier index and the offsets of the region are coded in the bitstream. In HEVC and VVC, the region (the unit for SAO parameters signaling) is defined to be a CTU.

Two SAO types that can satisfy the requirements of low complexity are adopted in HEVC. Those two types are edge offset (EO) and band offset (BO), which are discussed in further detail below. An index of an SAO type is coded (which is in the range of [0, 2]). For EO, the sample classification is based on comparison between current samples and neighboring samples according to 1-D directional patterns: horizontal, vertical, 135° diagonal, and 45° diagonal.

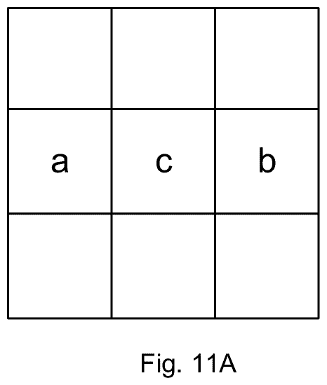

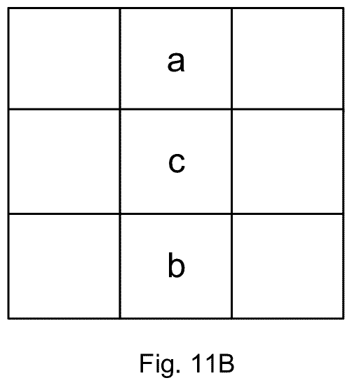

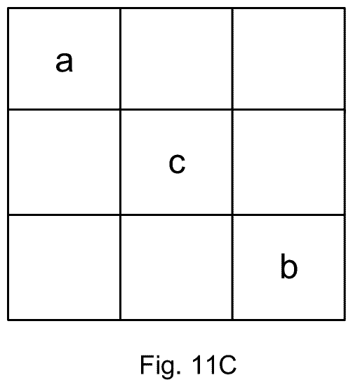

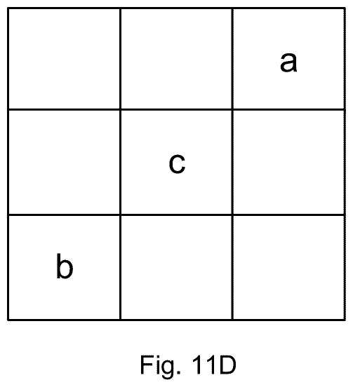

FIGS. 11A to 11D shows four 1-D directional patterns for EO sample classification: horizontal (EO class=0), vertical (EO class=1), 135° diagonal (EO class=2), and 45° diagonal (EO class=3).

For a given EO class, each sample inside the CTB is classified into one of five categories. The current sample value, labeled as “c,” is compared with its two neighbors along the selected 1-D pattern. The classification rules for each sample are summarized in Table 1. Categories 1 and 4 are associated with a local valley and a local peak along the selected 1-D pattern, respectively. Categories 2 and 3 are associated with concave and convex corners along the selected 1-D pattern, respectively. If the current sample does not belong to EO categories 1-4, then it is category 0 and SAO is not applied.

TABLE 3
Sample Classification Rules for Edge Offset

| Category | Condition |
|---|---|
| 1 | c < a and c < b |
| 2 | (c < a && c == b) \|\| (c == a && c < b) |
| 3 | (c > a && c == b) \|\| (c == a && c > b) |
| 4 | c > a && c > b |
| 5 | None of above |

### 2.6. Geometry Transformation-Based Adaptive Loop Filter in JEM

The input of DB is the reconstructed samples after DB and SAO. The sample classification and filtering process are based on the reconstructed samples after DB and SAO.

In the JEM, a geometry transformation-based adaptive loop filter (GALF) with block-based filter adaption [3] is applied. For the luma component, one among 25 filters is selected for each 2×2 block, based on the direction and activity of local gradients.

### 2.6.1. Filter Shape

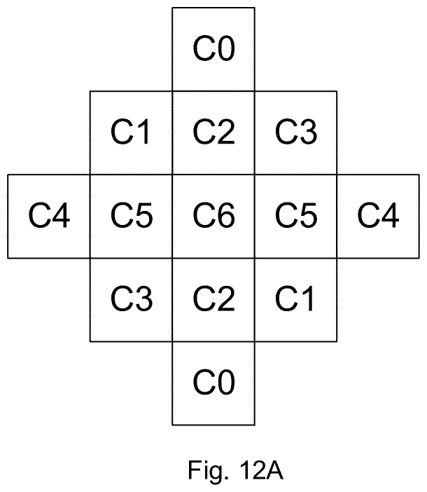

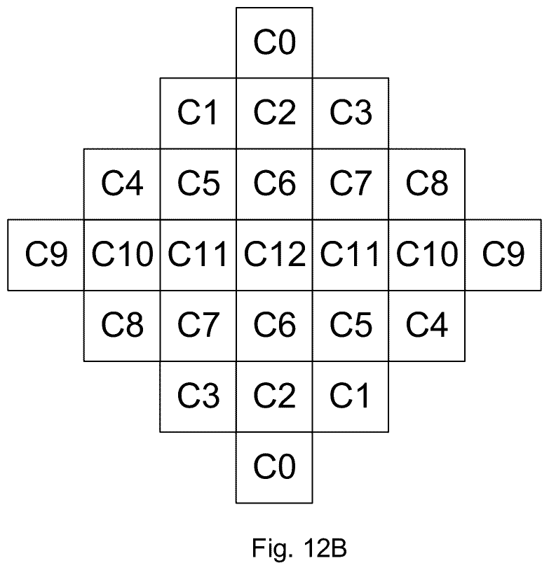

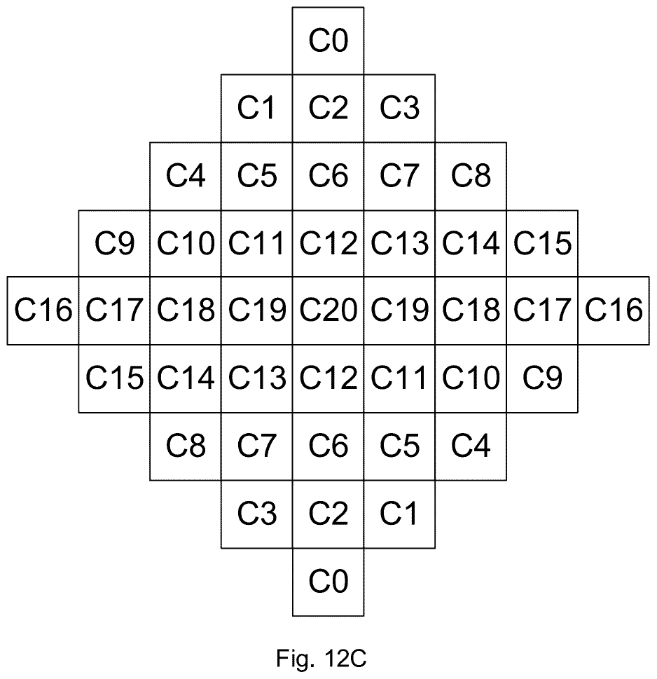

In the JEM, up to three diamond filter shapes (as shown in FIGS. 12A-12C) can be selected for the luma component. An index is signalled at the picture level to indicate the filter shape used for the luma component.

Each square represents a sample, and Ci (i being 0-6 (left), 0-12 (middle), 0-20 (right)) denotes the coefficient to be applied to the sample. For chroma components in a picture, the 5×5 diamond shape is always used.

FIGS. 12A-12C show GALF filter shapes (left: 5×5 diamond, middle: 7×7 diamond, right: 9×9 diamond).

### 2.6.1.1. Block Classification

Each 2×2 block is categorized into one out of 25 classes. The classification index C is derived based on its directionality D and a quantized value of activity Â, as follows:

$$C = 5 D + \hat{A} . \qquad ( 1 )$$

To calculate D and Â, gradients of the horizontal, vertical and two diagonal direction are first calculated using 1-D Laplacian:

$${g}_{ν} = {\sum }_{k = i - 2}^{i + 3} {\sum }_{l = j - 2}^{j + 3} {V}_{k , 1} , {V}_{k , l} = \vert 2 R ( k , l ) - R ( k , l - 1 ) - R ( k , l + 1 ) \vert , \qquad ( 2 )$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert , \qquad ( 3 )$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert \qquad ( 4 )$$

$${g}_{d 2} = {\sum }_{k = i - 2}^{i + 3} {\sum }_{j = j - 2}^{j + 3} D {2}_{k , l} , D {2}_{k , 1} = \vert 2 R ( k , l ) - R ( k - 1 , l + 1 ) - R ( k + 1 , l - 1 ) \vert \qquad ( 5 )$$

Indices i and j refer to the coordinates of the upper left sample in the 2×2 block and R(i,j) indicates a reconstructed sample at coordinate (i,j).

Then D maximum and minimum values of the gradients of horizontal and vertical directions are set as:

$${g}_{h , v}^{max} = max ( {g}_{h} , {g}_{v} ) , {g}_{h , v}^{min} = min ( {g}_{h} , {g}_{v} ) ,$$

and the maximum and minimum values of the gradient of two diagonal directions are set as:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) , \qquad ( 7 )$$

To derive the value of the directionality D, these values are compared against each other and with two thresholds t₁ and t₂:

Step 1. If both

$${g}_{h , ν}^{max} \leq {t}_{1} \cdot {g}_{h , v}^{min} and {g}_{d 0 , d 1}^{max} \leq {t}_{1} \cdot {g}_{d 0 , d 1}^{min}$$

are true, D is set to 0.

Step 2. If

$${g}_{h , ν}^{max} / {g}_{h , ν}^{min} > {g}_{d 0 , d 1}^{max} / {g}_{d 0 , d 1}^{min} ,$$

continue from Step 3; otherwise continue from Step 4.

Step 3. If

$${g}_{h , v}^{max} > {t}_{2} \cdot {g}_{h , v}^{min} ,$$

D is set to 2; otherwise D is set to 1.

Step 4. If

$${g}_{d 0 , d 1}^{max} > {t}_{2} \cdot {g}_{h , v}^{min} ,$$

D is set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) . \qquad ( 8 )$$

A is further quantized to the range of 0 to 4, inclusively, and the quantized value is denoted as Â.

For both chroma components in a picture, no classification method is applied, i.e. a single set of ALF coefficients is applied for each chroma component.

### 2.6.1.2. Geometric Transformations of Filter Coefficients

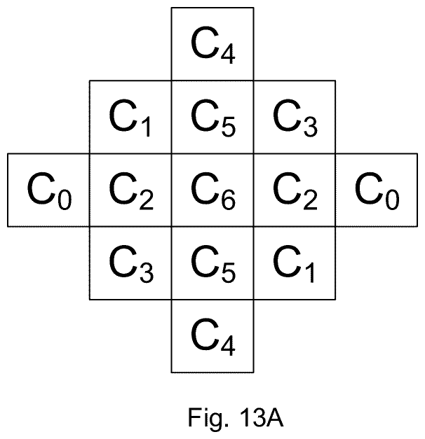

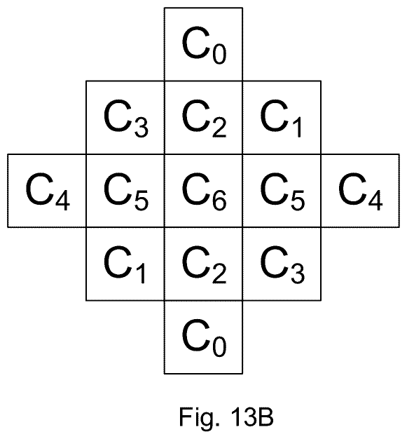

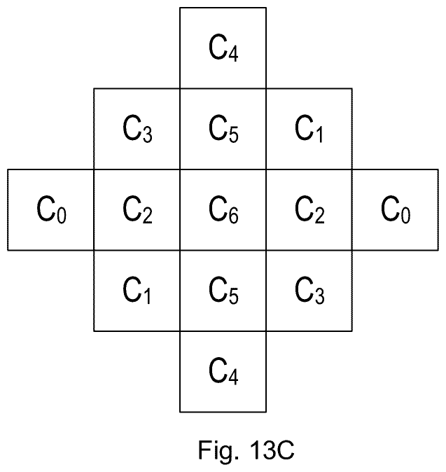

FIG. 13A shows relative coordinator for the 5×5 diamond filter support in case of diagonal. FIG. 13B shows relative coordinator for the 5×5 diamond filter support in case of vertical flip. FIG. 13C shows relative coordinator for the 5×5 diamond filter support in case of rotation.

Before filtering each 2×2 block, geometric transformations such as rotation or diagonal and vertical flipping are applied to the filter coefficients f(k,l), which is associated with the coordinate (k,l), depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:

$$\begin{matrix}Diagonal : {f}_{D} ( k , l ) = f ( l , k ) , \\ Vertical flip : {f}_{V} ( k , l ) = f ( k , K - l - 1 ) , \\ Rotation : {f}_{R} ( k , l ) = f ( K - l - 1 , k ) .\end{matrix} \qquad ( 9 )$$

where K is the size of the filter and 0≤k, l≤K−1 are coefficients coordinates, such that location (0,0) is at the upper left corner and location (K−1, K−1) is at the lower right corner. The transformations are applied to the filter coefficients f(k,l) depending on gradient values calculated for that block. The relationship between the transformation and the four gradients of the four directions are summarized in Table 4. FIGS. 13A-13C show the transformed coefficients for each position based on the 5×5 diamond.

TABLE 4
Mapping of the gradient calculated for
one block and the transformations

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### 2.6.1.3. Filter Parameters Signalling

In the JEM, GALF filter parameters are signalled for the first CTU, i.e., after the slice header and before the SAO parameters of the first CTU. Up to 25 sets of luma filter coefficients could be signalled. To reduce bits overhead, filter coefficients of different classification can be merged. Also, the GALF coefficients of reference pictures are stored and allowed to be reused as GALF coefficients of a current picture. The current picture may choose to use GALF coefficients stored for the reference pictures and bypass the GALF coefficients signalling.

In this case, only an index to one of the reference pictures is signalled, and the stored GALF coefficients of the indicated reference picture are inherited for the current picture.

To support GALF temporal prediction, a candidate list of GALF filter sets is maintained. At the beginning of decoding a new sequence, the candidate list is empty. After decoding one picture, the corresponding set of filters may be added to the candidate list. Once the size of the candidate list reaches the maximum allowed value (i.e., 6 in current JEM), a new set of filters overwrites the oldest set in decoding order, and that is, first-in-first-out (FIFO) rule is applied to update the candidate list. To avoid duplications, a set could only be added to the list when the corresponding picture doesn't use GALF temporal prediction. To support temporal scalability, there are multiple candidate lists of filter sets, and each candidate list is associated with a temporal layer. More specifically, each array assigned by temporal layer index (TempIdx) may compose filter sets of previously decoded pictures with equal to lower TempIdx. For example, the k-th array is assigned to be associated with TempIdx equal to k, and it only contains filter sets from pictures with TempIdx smaller than or equal to k. After coding a certain picture, the filter sets associated with the picture will be used to update those arrays associated with equal or higher TempIdx.

Temporal prediction of GALF coefficients is used for inter coded frames to minimize signalling overhead. For intra frames, temporal prediction is not available, and a set of 16 fixed filters is assigned to each class. To indicate the usage of the fixed filter, a flag for each class is signalled and if required, the index of the chosen fixed filter.

Even when the fixed filter is selected for a given class, the coefficients of the adaptive filter f(k,l) can still be sent for this class in which case the coefficients of the filter which will be applied to the reconstructed image are sum of both sets of coefficients.

The filtering process of luma component can controlled at CU level. A flag is signalled to indicate whether GALF is applied to the luma component of a CU. For chroma component, whether GALF is applied or not is indicated at picture level only.

### 2.6.1.4. Filtering Process

At decoder side, when GALF is enabled for a block, each sample R(i,j) within the block is filtered, resulting in sample value R′(i,j) as shown below, where L denotes filter length, f_{m,n} represents filter coefficient, and f(k,l) denotes the decoded filter coefficients.

$${R}^{′} ( i , j ) = {\sum }_{k = - L / 2}^{L / 2} {\sum }_{l = - L / 2}^{L / 2} f ( k , l ) \times R ( i + k , j + l ) \qquad ( 10 )$$

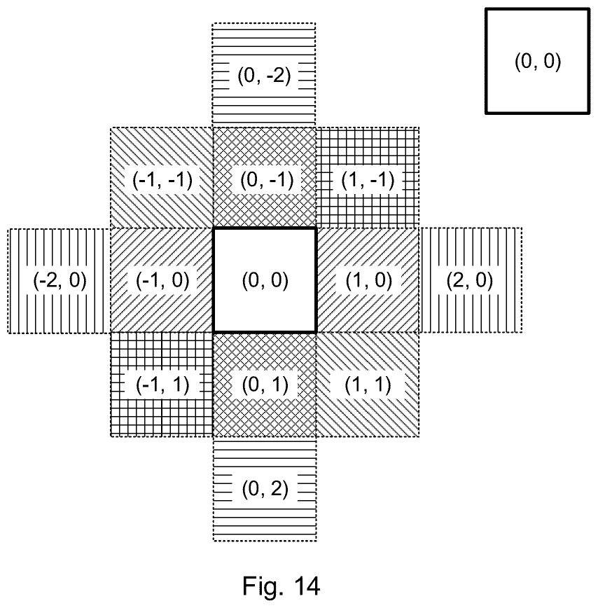

FIG. 14 shows an example of relative coordinates used for 5×5 diamond filter support supposing the current sample's coordinate (i,j) to be (0,0). Samples in different coordinates filled with the same color are multiplied with the same filter coefficients. In FIG. 14. examples of relative coordinates for the 5×5 diamond filter support are provided.

### 2.7. Geometry Transformation-Based Adaptive Loop Filter (GALF) in VVC

### 2.7.1. GALF in VTM-4

In VTM4.0, the filtering process of the Adaptive Loop Filter, is performed as follows:

$$O ( x , y ) = {\sum }_{( i , j )} w ( i , j ) \cdot I ( x + i , y + j ) , \qquad ( 11 )$$

where samples I(x+i, y+j) are input samples, O(x,y) is the filtered output sample (i.e. filter result), and w(i,j) denotes the filter coefficients. In practice, in VTM4.0 it is implemented using integer arithmetic for fixed point precision computations:

$$O ( x , y ) = ( {\sum }_{i = - \frac{L}{2}}^{\frac{L}{2}} {\sum }_{j = - \frac{L}{2}}^{\frac{L}{2}} w ( i , j ) \cdot I ( x + i , y + j ) + 64 ) ≫ 7 , \qquad ( 12 )$$

where L denotes the filter length, and where w(i,j) are the filter coefficients in fixed point precision.

The current design of GALF in VVC has the following major changes compared to that in JEM:
1) The adaptive filter shape is removed. Only 7×7 filter shape is allowed for luma component and 5×5 filter shape is allowed for chroma component.
2) Signaling of ALF parameters in removed from slice/picture level to CTU level.
3) Calculation of class index is performed in 4×4 level instead of 2×2. In addition, as proposed in JVET-L0147, sub-sampled Laplacian calculation method for ALF classification is utilized. More specifically, there is no need to calculate the horizontal/vertical/45 diagonal/135 degree gradients for each sample within one block. Instead, 1:2 subsampling is utilized.

### 2.8. Non-Linear ALF in Current VVC

### 2.8.1. Filtering Reformulation

Equation (11) can be reformulated, without coding efficiency impact, in the following expression:

$$O ( x , y ) = I ( x , y ) + {\sum }_{( i , j ) \neq ( 0 , 0 )} w ( i , ) \cdot ( I ( x + i , y + j ) - I ( x , y ) ) , \qquad ( 13 )$$

where w(i,j) are the same filter coefficients as in equation (11) [excepted w(0,0) which is equal to 1 in equation (13) while it is equal to 1−Σ_{(i,j)≠(0,0)}w(i,j) in equation (11)].

Using this above filter formula of (13), VVC introduces the non-linearity to make ALF more efficient by using a simple clipping function to reduce the impact of neighbor sample values (I(x+i,y+j)) when they are too different with the current sample value (I(x,y)) being filtered.

More specifically, the ALF filter is modified as follows:

$${O}^{′} ( x , y ) = I ( x , y ) + {\sum }_{( i , j ) \neq ( 0 , 0 )} w ( i , j ) \cdot K ( I ( x + i , y + j ) - I ( x , y ) , k ( i , j ) ) , \qquad ( 14 )$$

where K(d,b)=min(b, max(−b,d)) is the clipping function, and k(i,j) are clipping parameters, which depends on the (i,j) filter coefficient. The encoder performs the optimization to find the best k(i,j).

In the JVET-N0242 implementation, the clipping parameters k(i,j) are specified for each ALF filter, one clipping value is signaled per filter coefficient. It means that up to 12 clipping values can be signalled in the bitstream per Luma filter and up to 6 clipping values for the Chroma filter.

In order to limit the signaling cost and the encoder complexity, only 4 fixed values which are the same for INTER and INTRA slices are used.

Because the variance of the local differences is often higher for Luma than for Chroma, two different sets for the Luma and Chroma filters are applied. The maximum sample value (here 1024 for 10 bits bit-depth) in each set is also introduced, so that clipping can be disabled if it is not necessary.

The sets of clipping values used in the JVET-N0242 tests are provided in the Table 5. The 4 values have been selected by roughly equally splitting, in the logarithmic domain, the full range of the sample values (coded on 10 bits) for Luma, and the range from 4 to 1024 for Chroma.

More precisely, the Luma table of clipping values have been obtained by the following formula:

$${AlfClip}_{L} = \{ round ( {( {( M )}^{\frac{1}{N}} )}^{N - n + 1} ) for n ∈ 1 ¨ N ] \} , with M = {2}^{10} and N = 4. \qquad ( 16 )$$

Similarly, the Chroma tables of clipping values is obtained according to the following formula:

$${AlfClip}_{L} = \{ round ( A \cdot {( {( \frac{M}{A} )}^{\frac{1}{N - 1}} )}^{N - n} ) for n ∈ 1 ¨ N ] \} , with M = {2}^{10} , N = 4 and A = 4. \qquad ( 16 )$$

TABLE 5
Authorized clipping values

| | INTRA/INTER tile group |
|---|---|
| LUMA | {1024, 181, 32, 6} |
| CHROMA | {1024, 161, 25, 4} |

The selected clipping values are coded in the “alf_data” syntax element by using a Golomb encoding scheme corresponding to the index of the clipping value in the above Table 5. This encoding scheme is the same as the encoding scheme for the filter index.

### 2.9. Convolutional Neural Network-Based Loop Filters for Video Coding

### 2.9.1. Convolutional Neural Networks

In deep learning, a convolutional neural network (CNN, or ConvNet) is a class of deep neural networks, most commonly applied to analyzing visual imagery. They have very successful applications in image and video recognition/processing, recommender systems, image classification, medical image analysis, natural language processing.

CNNs are regularized versions of multilayer perceptrons. Multilayer perceptrons usually mean fully connected networks, that is, each neuron in one layer is connected to all neurons in the next layer. The “fully-connectedness” of these networks makes them prone to overfitting data. Typical ways of regularization include adding some form of magnitude measurement of weights to the loss function. CNNs take a different approach towards regularization: they take advantage of the hierarchical pattern in data and assemble more complex patterns using smaller and simpler patterns. Therefore, on the scale of connectedness and complexity, CNNs are on the lower extreme.

CNNs use relatively little pre-processing compared to other image classification/processing algorithms. This means that the network learns the filters that in traditional algorithms were hand-engineered. This independence from prior knowledge and human effort in feature design is a major advantage.

### 2.9.2. Deep Learning for Image/Video Coding

Deep learning-based image/video compression typically has two implications: end-to-end compression purely based on neural networks and traditional frameworks enhanced by neural networks. The first type usually takes an auto-encoder like structure, either achieved by convolutional neural networks or recurrent neural networks.

While purely relying on neural networks for image/video compression can avoid any manual optimizations or hand-crafted designs, compression efficiency may be not satisfactory. Therefore, works distributed in the second type take neural networks as an auxiliary, and enhance traditional compression frameworks by replacing or enhancing some modules. In this way, they can inherit the merits of the highly optimized traditional frameworks.

For example, Li et al. propose a fully connected network for the intra prediction in HEVC. In addition to intra prediction, deep learning is also exploited to enhance other modules. For example, Dai et al. replace the in-loop filters of HEVC with a convolutional neural network and achieve promising results. The work applies neural networks to improve the arithmetic coding engine.

### 2.9.3. Convolutional Neural Network Based in-Loop Filtering

In lossy image/video compression, the reconstructed frame is an approximation of the original frame, since the quantization process is not invertible and thus incurs distortion to the reconstructed frame. To alleviate such distortion, a convolutional neural network could be trained to learn the mapping from the distorted frame to the original frame. In practice, training must be performed prior to deploying the CNN-based in-loop filtering.

### 2.9.3.1. Training

The purpose of the training processing is to find the optimal value of parameters including weights and bias.

First, a codec (e.g. HM, JEM, VTM, etc.) is used to compress the training dataset to generate the distorted reconstruction frames.

Then the reconstructed frames are fed into the CNN and the cost is calculated using the output of CNN and the groundtruth frames (original frames). Commonly used cost functions include SAD (Sum of Absolution Difference) and MSE (Mean Square Error). Next, the gradient of the cost with respect to each parameter is derived through the back propagation algorithm. With the gradients, the values of the parameters can be updated.

The above process repeats until the convergence criteria is met. After completing the training, the derived optimal parameters are saved for use in the inference stage.

### 2.9.3.2. Convolution Process

During convolution, the filter is moved across the image from left to right, top to bottom, with a one-pixel column change on the horizontal movements, then a one-pixel row change on the vertical movements. The amount of movement between applications of the filter to the input image is referred to as the stride, and it is almost always symmetrical in height and width dimensions. The default stride or strides in two dimensions is (1,1) for the height and the width movement.

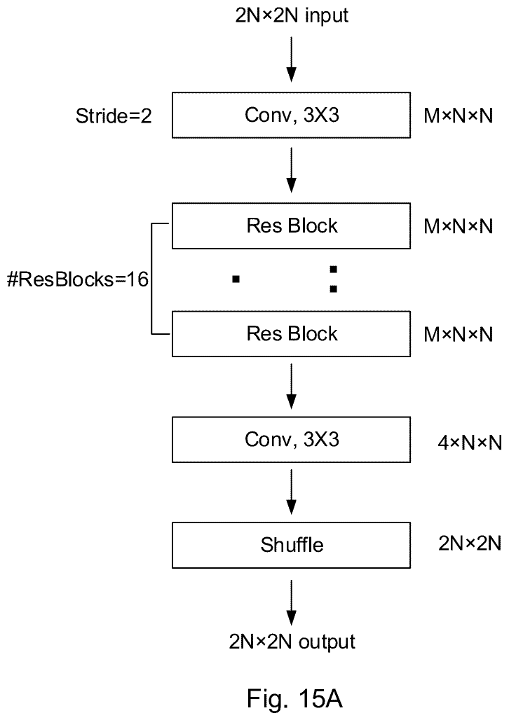

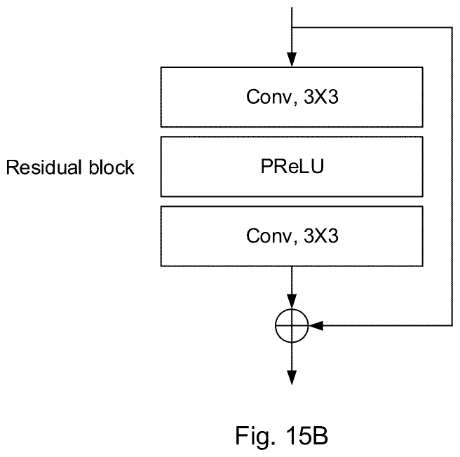

In most of deep convolutional neural networks, residual blocks are utilized as the basic module and stacked several times to construct the final network wherein in one example, the residual block is obtained by combining a convolutional layer, a ReLU/PReLU activation function and a convolutional layer as shown in FIG. 15A and FIG. 15B.

FIG. 15A shows an architecture of a typically used CNN. M denotes the number of feature maps. N stands for the number of samples in one dimension. FIG. 15B shows construction of ResBlock (residual block) in FIG. 15A.

### 2.9.3.3. Inference

During the inference stage, the distorted reconstruction frames are fed into CNN and processed by the CNN model whose parameters are already determined in the training stage. The input samples to the CNN can be reconstructed samples before or after DB, or reconstructed samples before or after SAO, or reconstructed samples before or after ALF.

### 3. Problems

Current neural network-based coding tools have the following problems:
1. The performance-complexity trade-off needs to be improved further. For example, higher coding gains are achieved at the cost of neural networks with higher computational complexity. To obtain better trade-off, more efficient network architectures should be studied.
2. Most video coding tools are based on network architectures inherited from computer vision tasks such as image classification, object detection, etc. or image restoration tasks such as image super-resolution, image denoising, etc.

### 4. Embodiments

The detailed embodiments below should be considered as examples to explain general concepts. These embodiments should not be interpreted in a narrow way. Furthermore, these embodiments can be combined in any manner.

One or more neural network (NN) models are trained as coding tools to improve the efficiency of video coding.

Those NN-based coding tools can be used to replace or enhance the modules involved in a video codec. For example, a NN model can serve as an additional intra prediction mode, inter prediction mode, transform kernel, or loop-filter. These embodiments elaborates how to design a NN model by using external information such as prediction, split, QP, etc. as attention.

It should be noted that the NN models could be used as any coding tools, such as NN-based intra/inter prediction, NN-based super-resolution, NN-based motion compensation, NN-based reference generation, NN-based fractional pixel interpolation, NN-based in-loop/post filtering, etc.

In the disclosure, a NN model can be any kind of NN architectures, such as a convolutional neural network or a fully connected neural network, or a combination of convolutional neural networks and fully connected neural networks.

In the following discussion, a video unit may be a sequence, a picture, a slice, a tile, a brick, a subpicture, a CTU/CTB, a CTU/CTB row, one or multiple CUs/CBs, one ore multiple CTUs/CTBs, one or multiple VPDU (Virtual Pipeline Data Unit), a sub-region within a picture/slice/tile/brick. A father video unit represents a unit larger than the video unit. Typically, a father unit will contain several video units. E.g., when the video unit is CTU, the father unit could be slice, CTU row, multiple CTUs, etc.

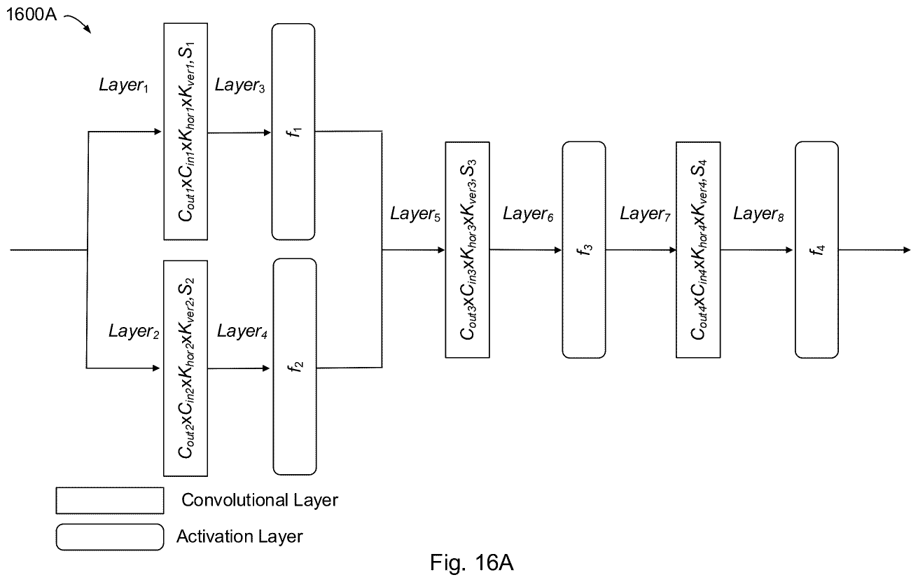

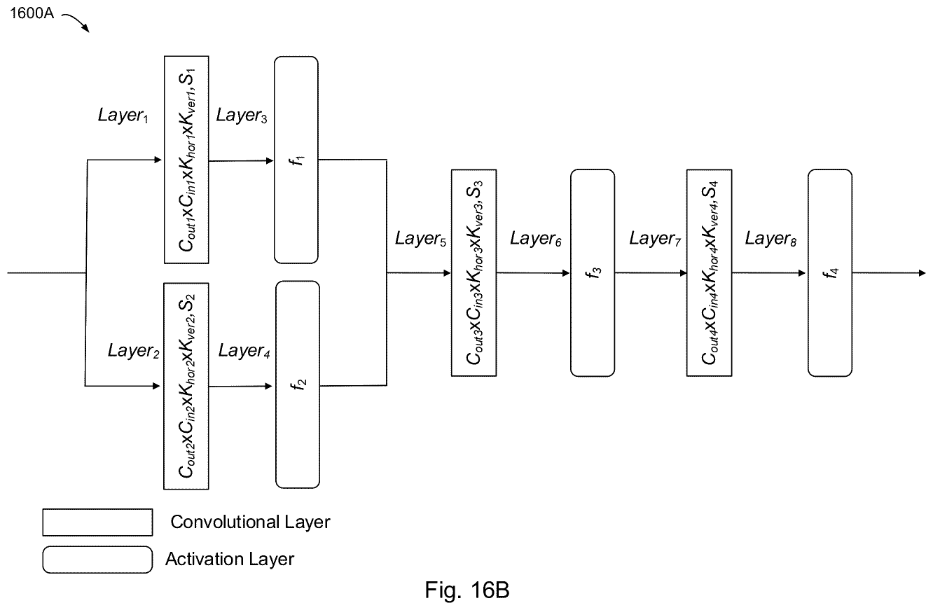

On a new type of basic block
1. The blocks shown in FIG. 16A and/or FIG. 16B and/or any variances of them may serve as the basic block for constructing a NN model. FIGS. 16A-16B show the basic blocks contained in NN models.
   a. In one example, in FIGS. 16A-16B, regular rectangles stand for convolutional layers (Layer₁, Layer₂, Layer₅, Layer₇) while rounded rectangles represent activation layers (Layer₃, Layer₄, Layer₆, Layer₈). The arrow illustrates the flow of data. The output of previous layer is taken as the input of next layer according to the direction of arrows. Cₒᵤₜ, Cᵢₙ, Kₕₒᵣ, Kᵥₑᵣ, S refer to number of output channels, number of input channels, kernel size in the horizontal direction, kernel size in the vertical direction, and stride of a convolutional layer, respectively. Compared with (a), (b) includes a skip connection at the end, i.e. the input to Layer₁ (which is also the input to Layer₂) is added to the output of Layer₈.
   b. In case the output of previous layer is fed into multiple next layers, the input to each next layer is the same as the output.
   c. In case outputs of multiple previous layers are fed into the next layer, the input to the next layer is the concatenation of these outputs along the channel dimension.
2. The activation layers shown in FIGS. 16A-16B may be configured in any flexible manner.
   a. In one example, at least one of the activation layers in FIG. 16A and/or FIG. 16B is a non-linear function.
   b. In one example, at least one of the activation layers in FIG. 16A and/or FIG. 16B is a linear function.
   c. In one example, Layer₃ and/or Layer₄ (i.e. f₁ and/or f₂) in FIG. 16A and/or FIG. 16B are PReLU (Parametric Rectified Linear Unit).
   d. In one example, Layer₃ and/or Layer₄ (i.e. f₁ and/or f₂) in FIG. 16A and/or FIG. 16B are LReLU (Leaky Rectified Linear Unit).
   e. In one example, Layer₃ and/or Layer₄ (i.e. f₁ and/or f₂) in FIG. 16A and/or FIG. 16B are ReLU (Rectified Linear Unit).
   f. In one example, Layer₆ and/or Layer₈ (i.e. f₃ and/or f₄) in FIG. 16A and/or FIG. 16B are identity mapping functions (output and input of the layer are exactly the same).
   g. In one example, Layer₆ and/or Layer₈ (i.e. f₃ and/or f₄) in FIG. 16A and/or FIG. 16B are PReLU (Parametric Rectified Linear Unit).
   h. In one example, Layer₆ and/or Layer₈ (i.e. f₃ and/or f₄) in FIG. 16A and/or FIG. 16B are LReLU (Leaky Rectified Linear Unit).
   i. In one example, Layer₆ and/or Layer₈ (i.e. f₃ and/or f₄) in FIG. 16A and/or FIG. 16B are ReLU (Rectified Linear Unit).
   j. In one example, all the activation layers in FIG. 16A and/or FIG. 16B are PReLU (Parametric Rectified Linear Unit).
   k. In one example, all the activation layers in FIG. 16A and/or FIG. 16B are LReLU (Leaky Rectified Linear Unit).
   l. In one example, all the activation layers in FIG. 16A and/or FIG. 16B are ReLU (Rectified Linear Unit).
   m. In one example, Layer₃ and/or Layer₄ (i.e. f₁ and/or f₂) in FIG. 16A and/or FIG. 16B are non-linear functions while Layer₆ and/or Layer₈ (i.e. f₃ and/or f₄) in FIG. 16A and/or FIG. 16B are linear functions.
   n. In one example, Layer₃ and/or Layer₄ (i.e. f₁ and/or f₂) in FIG. 16A and/or FIG. 16B are non-linear functions while Layer₆ and/or Layer₈ (i.e. f₃ and/or f₄) in FIG. 16A and/or FIG. 16B are identity mapping functions.
      i. In one example, Layer₃ and Layer₄ (i.e. f₁ and f₂) in FIG. 16A and FIG. 16B are PReLU (Parametric Rectified Linear Unit) while Layer₆ and Layer₈ (i.e. f₃ and f₄) in FIG. 16A and FIG. 16B are identity mapping functions.
   o. In one example, which configuration to be used may be determined by decoded information.
   p. In one example, which configuration to be used may be determined by at least one syntax element signaled from encoder to decoder.
3. The convolutional layers shown in FIGS. 16A-16B may be configured in any flexible manner.
   a. In one example, kernel sizes in all layers are the same, e.g. 1×1, 3×3, 5×5, etc.
   b. In one example, kernel sizes in all layers are different.
   c. In one example, kernel sizes in Layer₁ and Layer₂ are different while kernel sizes in Layer⁵ and Layer₇ are the same.
      i. In one example, kernel sizes in Layer₁ and Layer₂ are 1×1 and 3×3 respectively, while kernel sizes in Layer₅ and Layer₇ are both 3×3.
      ii. In one example, kernel sizes in Layer₁ and Layer₂ are 1×1 and 5×5 respectively, while kernel sizes in Layer₅ and Layer₇ are both 3×3.
      iii. In one example, kernel sizes in Layer₁ and Layer₂ are 3×3 and 1×1 respectively, while kernel sizes in Layer₅ and Layer₇ are both 3×3.
      iv. In one example, kernel sizes in Layer₁ and Layer₂ are 5×5 and 1×1 respectively, while kernel sizes in Layer₅ and Layer₇ are both 3×3.
   d. In one example, kernel sizes in Layer₁ and Layer₂ are different, and kernel sizes in Layer₅ and Layer₇ are also different.
      i. In one example, kernel sizes in Layer₁ and Layer₂ are 1×1 and 3×3 respectively, and kernel sizes in Layer₅ and Layer₇ are 1×1 and 3×3 respectively.
      ii. In one example, kernel sizes in Layer₁ and Layer₂ are 3×3 and 1×1 respectively, and kernel sizes in Layer₅ and Layer₇ are 1×1 and 3×3 respectively.
   e. In one example, numbers of output channels (a.k.a. output feature maps) in all layers are the same, e.g. 32, 64, 96, 128, etc.
   f. In one example, numbers of output channels in all layers are different.
   g. In one example, numbers of output channels in Layer₁ and Layer₂ are different while numbers of output channels in Layer₅ and Layer₇ are the same.
      i. In one example, the number of output channels in Layer₁ is larger than that in Layer₂.
      ii. In one example, the number of output channels in Layer₁ is smaller than that in Layer₂.
   h. In one example, numbers of output channels in Layer₁ and Layer₂ are different, and numbers of output channels in Layer₅ and Layer₇ are also different.
      i. In one example, the number of output channels in Layer₁ is larger than that in Layer₂, and the number of output channels in Layer₅ is larger than that in Layer₇.
      ii. In one example, the number of output channels in Layer₁ is smaller than that in Layer₂, and the number of output channels in Layer₅ is larger than that in Layer₇.
   i. In one example, kernel sizes in Layer₁ and Layer₂ are different, kernel sizes in Layer₅ and Layer₇ are different, numbers of output channels in Layer₁ and Layer₂ are different, numbers of output channels in Layer₅ and Layer₇ are the same.
      i. In one example, denote the number of input channels to Layer₁ (which is also the input channels to Layer₂) as N. Numbers of output channels in Layer₁ and Layer₂ are set as N×C₁ and N×C₂, respectively, where C₁ is greater than 1.0 (e.g. 2.5) and C₂ is smaller than 1.0 (e.g. 0.5). Numbers of output channels in Layer₅ and Layer₇ are both set as N. Kernel sizes in Layer₁ and Layer₂ are 1×1 and 3×3 respectively, and kernel sizes in Layer₅ and Layer₇ are set as 1×1 and 3×3 respectively.
      ii. In one example, denote the number of input channels to Layer₁ (which is also the input channels to Layer₂) as N. Numbers of output channels in Layer₁ and Layer₂ are set as N×C₁ and N×C₂, respectively, where C₁ is smaller than 1.0 (e.g. 0.5) and C₂ is greater than 1.0 (e.g. 2.5). Numbers of output channels in Layer₅ and Layer₇ are both set as N. Kernel sizes in Layer₁ and Layer₂ are 1×1 and 3×3 respectively, and kernel sizes in Layer₅ and Layer₇ are set as 1×1 and 3×3 respectively.
      iii. In one example, given an integer number N (e.g. 32, 64, 96, 128, etc.), numbers of output channels in Layer₁ and Layer₂ are set as N×C₁ and N×C₂, respectively, where C₁ is greater than 1.0 (e.g. 2.5) and C₂ is smaller than 1.0 (e.g. 0.5). Numbers of output channels in Layer₅ and Layer₇ are both set as N. Kernel sizes in Layer₁ and Layer₂ are 1×1 and 3×3 respectively, and kernel sizes in Layer₅ and Layer₇ are set as 1×1 and 3×3 respectively.
      iv. In one example, given an integer number N (e.g. 32, 64, 96, 128, etc.), numbers of output channels in Layer₁ and Layer₂ are set as N×C₁ and N×C₂, respectively, where C₁ is smaller than 1.0 (e.g. 0.5) and C₂ is greater than 1.0 (e.g. 2.5). Numbers of output channels in Layer₅ and Layer₇ are both set as N. Kernel sizes in Layer₁ and Layer₂ are 1×1 and 3×3 respectively, and kernel sizes in Layer₅ and Layer₇ are set as 1×1 and 3×3 respectively.
   j. In one example, which configuration to be used may be determined by decoded information.
   k. In one example, which configuration to be used may be determined by at least one syntax element signaled from encoder to decoder.
4. The configurations in the above two bullets (bullet 2 and bullet 3) may be combined. Specifically, the activation layers may be configured using any sub-bullet from bullet 2 (2.a, 2.b, . . . , 2.p) while the convolutional layers may be configured using any sub-bullet from bullet 3 (3.a, 3.b, . . . , 3.k).
5. The activation layers and the convolutional layers shown in FIGS. 16A-16B may be jointly configured in certain manners to achieve better performance.
   a. In one example, Layer₃ and Layer₄ (i.e. f₁ and f₂) in FIG. 16A and/or FIG. 16B are non-linear functions while Layer₆ and Layer₈ (i.e. f₃ and f₄) in FIG. 16A and/or FIG. 16B are identity mapping functions. Kernel sizes in Layer₁ and Layer₂ are different, kernel sizes in Layer₅ and Layer₇ are different, numbers of output channels in Layer₁ and Layer₂ are different, numbers of output channels in Layer₅ and Layer₇ are the same.
      i. In one example, Layer₃ and Layer₄ (i.e. f₁ and f₂) in FIG. 16A and FIG. 16B are PReLU (Parametric Rectified Linear Unit).
      ii. In one example, Layer₃ and Layer₄ (i.e. f₁ and f₂) in FIG. 16A and FIG. 16B are LReLU (Leaky Rectified Linear Unit).
      iii. In one example, Layer₃ and Layer₄ (i.e. ft and f₂) in FIG. 16A and FIG. 16B are ReLU (Rectified Linear Unit).
      iv. In one example, kernel size in Layer₁ is smaller than that in Layer₂, kernel size in Layer₅ is smaller than that in Layer₇, number of output channels in Layer₁ is larger than that in Layer₂.
      v. In one example, kernel size in Layer₁ is larger than that in Layer₂, kernel size in Layer₅ is smaller than that in Layer₇, number of output channels in Layer₁ is smaller than that in Layer₂.

### On the NN Model

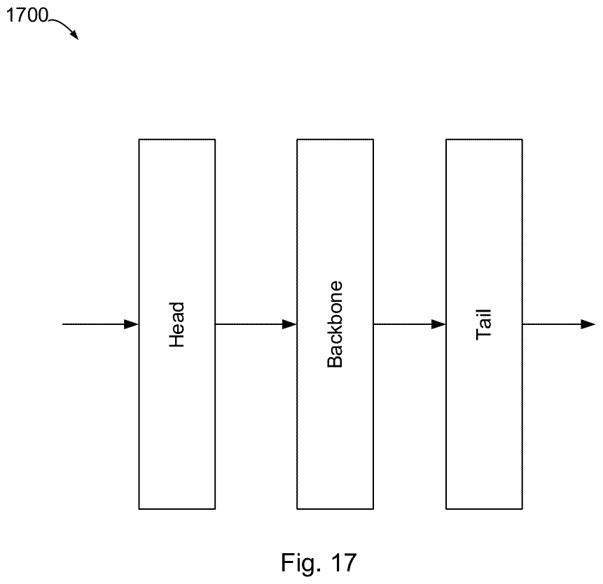

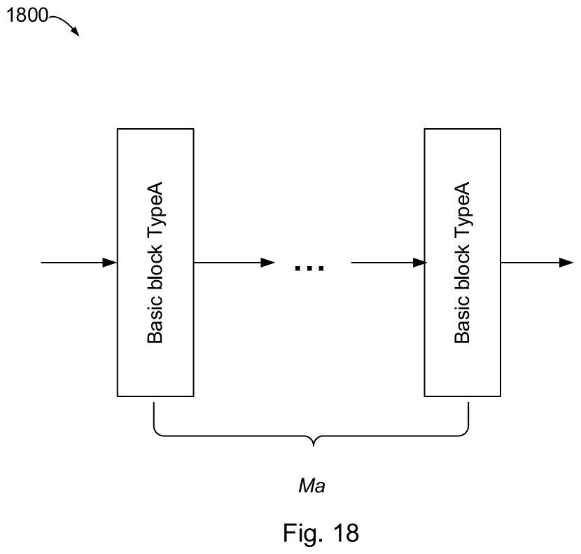

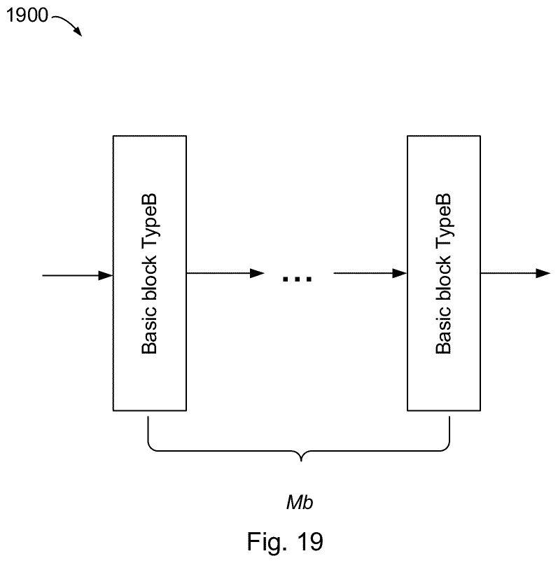

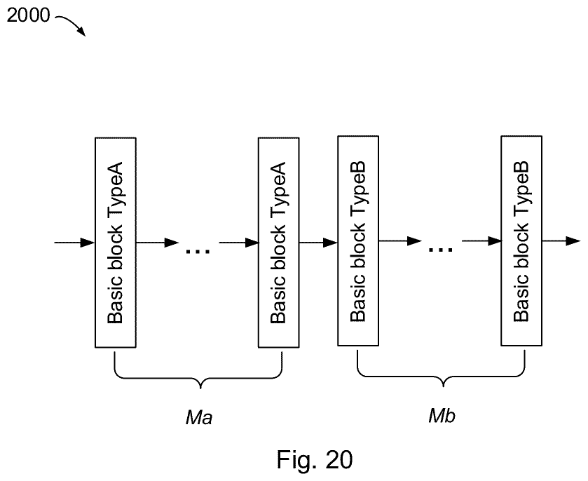

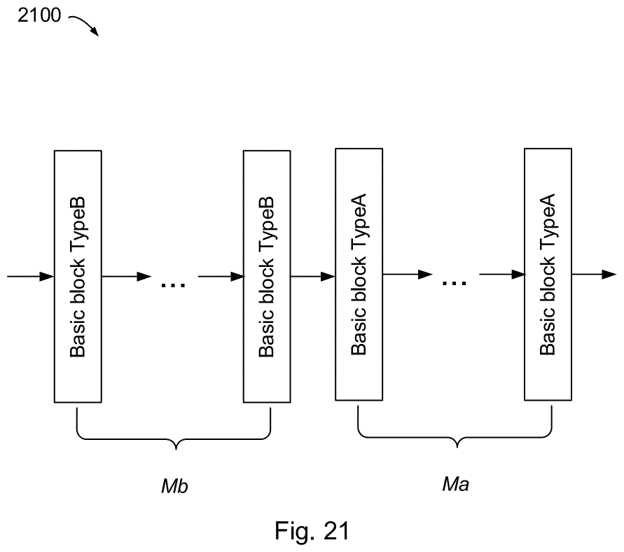

6. The NN model may comprise one or more basic blocks shown in FIGS. 16A-16B.
   a. In one example, the NN model comprises at least one basic block shown in FIG. 16A.
   b. In one example, the NN model comprises at least one basic block shown in FIG. 16B.
   c. In one example, the NN model comprises at least one basic block shown in FIG. 16A and at least one basic block shown in FIG. 16B.
7. The NN model may contain three parts as illustrated in FIG. 17, where the head part is responsible for extracting features from the input to the NN model, which are then fed into the backbone part for further feature mapping. The tail part transforms the output features of backbone part into the final output.
   a. In one example, the head part is designed in the way shown in FIG. 18, which shows a stack of basic blocks, where BasicBlockTypeA is the block shown in FIG. 16A, and Ma is the number of stacked blocks.
   b. In one example, the head part is designed in the way shown in FIG. 19 which shows a stack of basic blocks, where BasicBlockTypeB is the block shown in FIG. 16B, and Mb is the number of stacked blocks.
   c. In one example, the head part is designed in the way shown in FIG. 20 which shows a stack of basic blocks, where BasicBlockTypeA is the block shown in FIG. 16A, and BasicBlockTypeB is the block shown in FIG. 16B. Ma and Mb are the numbers of stacked blocks.
   d. In one example, the head part is designed in the way shown in FIG. 21 which shows a stack of basic blocks, where BasicBlockTypeB is the block shown in FIG. 16B, and BasicBlockTypeA is the block shown in FIG. 16A. Ma and Mb are the numbers of stacked blocks.
   e. In one example, the backbone part is designed in the way shown in FIG. 18.
   f. In one example, the backbone part is designed in the way shown in FIG. 19.
   g. In one example, the backbone part is designed in the way shown in FIG. 20.
   h. In one example, the backbone part is designed in the way shown in FIG. 21.
   i. In one example, the tail part is designed in the way shown in FIG. 18.
   j. In one example, the tail part is designed in the way shown in FIG. 19.
   k. In one example, the tail part is designed in the way shown in FIG. 20.
   l. In one example, the tail part is designed in the way shown in FIG. 21.
   m. In one example, the head part is designed in the way shown in FIG. 18. The backbone part is designed in the way shown in FIG. 21. The tail part is a regular convolutional layer.
8. In one example, only integer operations may be applied in the proposed architectures.
   a. No floating-point operations may be involved.
   b. No division operations may be involved.
   c. The integer operations may comprise “adding”, “multiplying”, “shifting”, “rounding”, “clipping”, etc.

### 5. Example Implementations

### 5.1. Synopsis

This contribution proposes a deep in-loop filter which is constructed based on basic residual blocks with wide activation and large receptive field. The proposed filter is implemented on top of NNVC common software NCS-1.0. BD-rate changes of {Y, Cb, Cr} on top of NCS-1.0 and NNVC-2.0 are reportedly summarized as below:
Anchored on NCS-1.0:
Normal: RA: {%, %, %}, LB: {%, %, %}, AI: {−1.55%, −1.94%, −2.12%}
Compact: RA: {%, %, %}, LB: {%, %, %}, AI: {%, %, %}
Anchored on NNVC-2.0:
Normal: RA: {%, %, %}, LB: {%, %, %}, AI: {−8.68%, −21.49%, −22.09%}
Compact: RA: {%, %, %}, LB: {%, %, %}, AI: {%, %, %}

### 5.2. Introduction

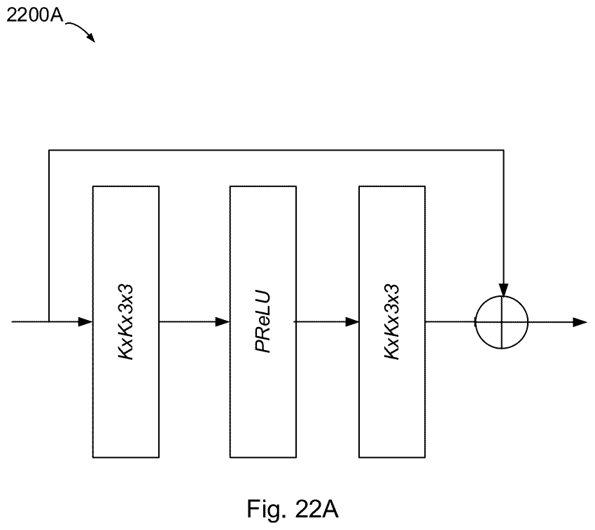

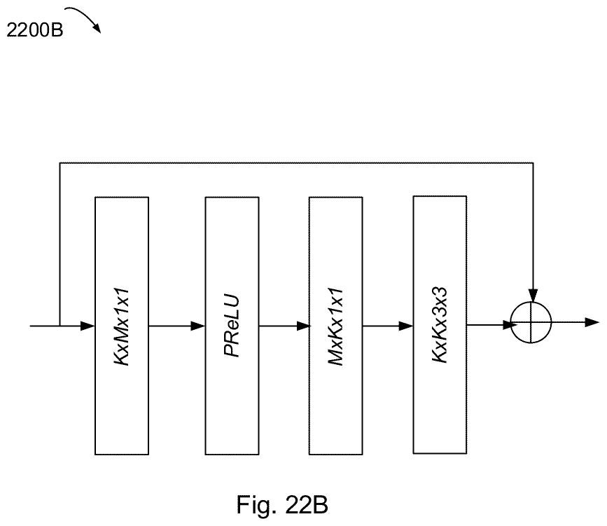

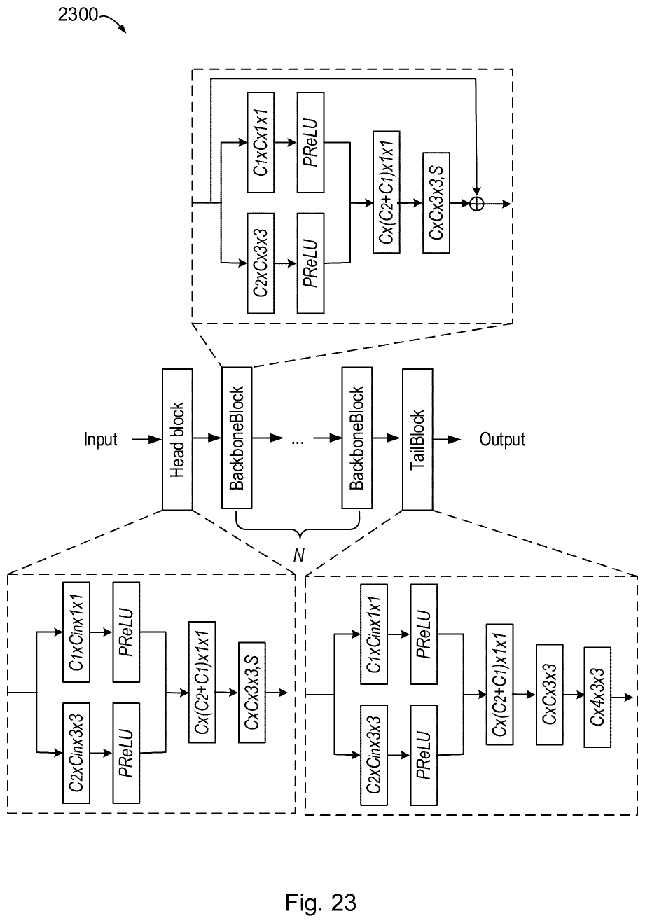

NNVC common software includes two sets of deep in-loop filter, where the filter set 1 is based on a residual block containing two 3×3 convolutional layers as shown in the example 2200A of FIG. 22A, which is a vanilla residual block. Studies have shown benefits to build a network using residual block with wide activation as shown in as shown in the example 2200B of FIG. 22B, which is a wide residual block with M>K. However, the receptive filter of wide residual block is restricted compared with the normal one. This contribution proposes a new type of residual block with both wide activation and large receptive field as shown in the architecture 2300 of FIG. 23. In addition, the proposed residual block allows multi-scale feature extraction.

### 5.3. Proposed Method

Section 2.1-2.4 present luma CNN structure, chroma CNN structure, inference and training process, respectively. Note that other designs of the proposed method such as parameter selection, residual scaling, combination with deblocking, etc. remain the same as the NN-based filter set 1 in NCS-1.0.

### 5.3.1. Luma CNN Structure

FIG. 23 gives the architecture of the proposed CNN filter for deep in-loop filtering, which comprises three types of basic blocks known as HeadBlock, BackboneBlock, and TailBlock. The design of these blocks follows the principle of wide activation, large receptive field, and multi-scale feature extraction.

HeadBlock is responsible for extracting features from input. Cᵢₙ denotes the number of input channels, and is equal to 5 for intra model (rec, pred, split, bs, qp) and 3 for inter model (rec, pred, qp). C stands for the basic number of feature maps and is set as 64. {C₁, C₂} represent numbers of output channels in large activation branch and large receptive field branch, and are set as {160, 32}. S means the stride of convolution and is set as 2 to achieve feature down-sampling. Backbone of the proposed network containing a series of BackboneBlocks achieves feature embedding. N, the number of BackboneBlocks, is set as 22 and 19 for the regular model and compact model. In the end, there is a TailBlock mapping the embedded features from backbone to the final output.

### 5.3.2. Chroma CNN Structure

The CNN filter for chroma components has similar architecture as that for luma, but includes less BackboneBlocks. In particular, N is set as 10.

### 5.3.3. Inference

SADL is used for performing the inference of the proposed CNN filters in VTM. Both weights and feature maps are represented with int16 precision using a static quantization method. The network information in the inference stage is provided in Table 6 as suggested.

TABLE 6
Network Information for NN-based Video Coding Tool Testing
in Inference Stage
Network Information in Inference Stage

| | HW environment: | |
|---|---|---|
| Mandatory | GPU Type | N/A |
| | Framework: | SADL |
| | Number of GPUs per | 0 |
| | Task | |
| | Total Parameter | compact: |
| | Number | 1.62M/luma model, 0.93M/chroma |
| | | model, 5.1M in total |
| | | regular: |
| | | 1.85M/luma model, 0.93M/chroma |
| | | model, 5.56M in total |
| | Parameter Precision | 16 (I) |
| | (Bits) | |
| | Memory Parameter | compact: |
| | (MB) | 3.3 MB/luma model, 1.9 MB/chroma |
| | | model, 10.4M in total |
| | | regular: |
| | | 3.7 MB/luma model, 1.9 MB/chroma |
| | | model, 11.2M in total |
| | Multiply Accumulate | compact: |
| | (kMAC/pixel) | 479K/pixel (frame-level input), |
| | | 606K/pixel (block-level input) |
| | | regular: |
| | | 537K/pixel (frame-level input), |
| | | 680K/pixel (block-level input) |
| Optional | Total Conv. Layers | compact: 85 |
| | | regular: 97 |
| | Total FC Layers | 0 |
| | Total Memory (MB) | |
| | Batch size: | 1 |
| | Patch size | 128 × 128, 256 × 256 |
| | Changes to network | |
| | configuration or | |
| | weights required to | |
| | generate rate points | |
| | Peak Memory Usage | |
| | Other information: | |

### 5.3.4. Training

PyTorch is used as the training platform. The DIV2K and BVI-DVCdatasets are adopted to train the CNN filters of I slices and B slices, respectively. The network information in the training stage is provided in Table 7 as suggested.

TABLE 7
Network Information for NN-based Video Coding Tool
Testing in Training Stage
Network Information in Training Stage

| | | |
|---|---|---|
| Mandatory | GPU Type | GPU: Tesla-V100-SXM2-32 GB |
| | Framework: | PyTorch v1.6 |
| | Number of GPUs per | 2 |
| | Task | |
| | Epoch: | 60 |
| | Batch size: | 64 |
| | Training time: | 70 h/model |
| | Training data information: | DIV2K, BVI-DVC |
| | Training configurations | VTM-11.0 + new MCTF, QP |
| | for generating compressed | {17, 22, 27, 32, 37, 42} |
| | training data (if | |
| | different to VTM CTC): | |
| | Loss function: | L1, L2 |
| Optional | Number of iterations | |
| | Patch size | 128 × 128 |
| | Learning rate: | 1e−4 |
| | Optimizer: | ADAM |
| | Preprocessing: | |
| | Other information: | |

### 5.4. Experimental Results

The proposed CNN-based in-loop filtering method is integrated into NCS-1.0 and tested according to the common test conditions. SAO is disabled while ALF (and CCALF) is placed after the proposed CNN-based filtering. To better evaluate the proposed method, it is compared with NN-based filter set 1 of NCS-1.0 and NNVC-2.0. Comparison results are shown in Table 8˜Table 13.

### Regular Model:

The proposed model with regular size includes 22 BackboneBlocks. Compared with NCS-1.0, the regular model brings on average {%, %, %}, {%, %, %}, and {−1.55%, −1.94%, −2.12%}BD-rate changes for {Y, Cb, Cr} under RA, LB, and AI configurations. Compared with NNVC-2.0 anchor, the regular model brings on average {%, %, %}, {%, %, %}, and {−8.68%, −21.49%, −22.09%}BD-rate changes for {Y, Cb, Cr} under RA, LB, and AI configurations.

### Compact Model:

The proposed model with regular size includes 19 BackboneBlocks. Compared with NCS-1.0, the regular model brings on average {%, %, %}, {%, %, %}, and {%, %, %}BD-rate changes for {Y, Cb, Cr} under RA, LB, and AI configurations. Compared with NNVC-2.0 anchor, the regular model brings on average {%, %, %}, {%, %, %}, and {%, %, %}BD-rate changes for {Y, Cb, Cr} under RA, LB, and AI configurations.

TABLE 8
RA performance anchored on NCS-1.0

| RA (regular model) | | | | | RA (compact model) | | | | |
|---|---|---|---|---|---|---|---|---|---|
| Y | U | V | EncT | DecT | Y | U | V | EncT | DecT |

Class A1
Class A2
Class B
Class C
Class E
Overall
Class D
Class F

TABLE 9
LDB performance anchored on NCS-1.0

| LDB (regular model) | | | | | LDB (compact model) | | | | |
|---|---|---|---|---|---|---|---|---|---|
| Y | U | V | EncT | DecT | Y | U | V | EncT | DecT |

Class A1
Class A2
Class B
Class C
Class E
Overall
Class D
Class F

TABLE 10
AI performance anchored on NCS-1.0

| AI (regular model) | | | | | AI (compact model) | | | | |
|---|---|---|---|---|---|---|---|---|---|
| Y | U | V | EncT | DecT | Y | U | V | EncT | DecT |

| | | | | | |
|---|---|---|---|---|---|
| Class A1 | −1.23% | −2.27% | −0.90% | 93% | 98% |
| Class A2 | −1.35% | −2.52% | −3.28% | 95% | 101% |
| Class B | −1.35% | 0.43% | −0.03% | 93% | 99% |
| Class C | −1.81% | −2.82% | −2.33% | 84% | 91% |
| Class E | −2.06% | −3.82% | −5.37% | 88% | 98% |
| Overall | −1.55% | −1.94% | −2.12% | 90% | 97% |
| Class D | −1.49% | −2.19% | −2.23% | 81% | 93% |
| Class F | −1.03% | −2.26% | −3.46% | 92% | 97% |

TABLE 11
RA performance anchored on NNVC-2.0

| RA (regular model) | | | | | RA (compact model) | | | | |
|---|---|---|---|---|---|---|---|---|---|
| Y | U | V | EncT | DecT | Y | U | V | EncT | DecT |

Class A1
Class A2
Class B
Class C
Class E
Overall
Class D
Class F

TABLE 12
LDB performance anchored on NNVC-2.0

| LDB (regular model) | | | | | LDB (compact model) | | | | |
|---|---|---|---|---|---|---|---|---|---|
| Y | U | V | EncT | DecT | Y | U | V | EncT | DecT |

Class A1
Class A2
Class B
Class C
Class E
Overall
Class D
Class F

TABLE 13
AI performance anchored on NNVC-2.0

| AI (regular model) | | | | | AI (compact model) | | | | |
|---|---|---|---|---|---|---|---|---|---|
| Y | U | V | EncT | DecT | Y | U | V | EncT | DecT |

| | | | | | |
|---|---|---|---|---|---|
| Class A1 | −7.60% | −19.62% | −20.43% | 196% | 40806% |
| Class A2 | −7.75% | −22.25% | −20.33% | 155% | 33947% |
| Class B | −7.76% | −21.28% | −21.51% | 147% | 31416% |
| Class C | −9.05% | −20.97% | −23.49% | 128% | 21229% |
| Class E | −11.72% | −23.66% | −24.60% | 151% | 35456% |
| Overall | −8.68% | −21.49% | −22.09% | 152% | 31090% |
| Class D | −8.69% | −21.10% | −22.99% | 123% | 18825% |
| Class F | −5.01% | −13.67% | −13.99% | 123% | 20987% |

### 5.5. Conclusions

This contribution proposes a CNN-based in-loop filtering network. The proposed method shows favorable trade-off in terms of the coding performance and complexity. It is suggested to study the proposed method in EE.

The embodiments of the present disclosure are related to use of a NN model for coding a video. One or more neural network (NN) models are trained as coding tools to improve the efficiency of video coding. Those NN-based coding tools can be used to replace or enhance the modules involved in a video codec. For example, a NN model can serve as an additional intra prediction mode, inter prediction mode, transform kernel, or loop-filter. This invention elaborates how to design a NN model by using external information such as prediction, split, QP, etc. as attention.

It should be noted that the NN models could be used as any coding tools, such as NN-based intra/inter prediction, NN-based super-resolution, NN-based motion compensation, NN-based reference generation, NN-based fractional pixel interpolation, NN-based in-loop/post filtering, etc.

In the disclosure, a NN model can be any kind of NN architectures, such as a convolutional neural network or a fully connected neural network, or a combination of convolutional neural networks and fully connected neural networks.

In the following discussion, a video unit may be a sequence, a picture, a slice, a tile, a brick, a subpicture, a coding tree unit (CTU), a coding tree block (CTB), a CTU row, a CTB row, one or multiple CUs/CBs, one ore multiple CTUs/CTBs, one or multiple VPDU (Virtual Pipeline Data Unit), one or multiple coding units (CUs), one or multiple coding blocks (CBs), one ore multiple CTUs, one ore multiple CTBs, one or multiple Virtual Pipeline Data Units (VPDUs), a sub-region within a picture/slice/tile/brick, an inference block. A father video unit represents a unit larger than the video unit. In some embodiments, the block may represent one or multiple samples, or one or multiple pixels. Typically, a father unit will contain several video units. E.g., when the video unit is CTU, the father unit could be slice, CTU row, multiple CTUs, etc.

The terms “frame” and “picture” can be used interchangeably. The terms “sample” and “pixel” can be used interchangeably.

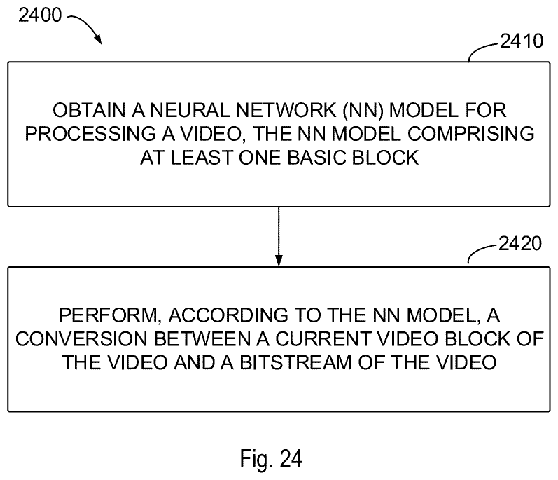

FIG. 24 illustrates a flowchart of a method 2400 for video processing in accordance with embodiments of the present disclosure.

At block 2410, a neural network (NN) model for processing a video is obtained. The NN model comprises at least one basic block. A basic block comprises: a plurality of branches for parallel processing an input of the basic block, a branch comprising at least one convolutional layer and at least one activation layer, and a plurality of layers for serial processing a combination of outputs of the plurality of branch, the plurality of layers comprising at least one convolutional layer and at least one activation layer a plurality of branches for parallel processing an input of the basic block, a branch comprising at least one convolutional layer and at least one activation layer, and a plurality of layers for serial processing a combination of outputs of the plurality of branch, the plurality of layers comprising at least one convolutional layer and at least one activation layer.

At block 2420, a conversion between a current video block of the video and a bitstream of the video is performed according to the NN model.

The method 2400 enables applying an efficient network architecture for video coding, which improve the performance-complexity trade-off. In this way, coding performance can be further improved.

FIG. 16A show a first type (Type A) of a basic block 1600A contained in NN models, and FIG. 16B shows a second type (Type B) of a basic block 1600B contained in NN models. In FIGS. 16A and 16B, regular rectangles stand for convolutional layers (Layer₁, Layer₂, Layer₅, Layer₇) while rounded rectangles represent activation layers (Layer₃,Layer₄, Layer₆, Layer₈). In FIGS. 16A and 16B, the arrow illustrates the flow of data. The output of previous layer is taken as the input of next layer according to the direction of arrows. Cₒᵤₜ, Cᵢₙ, Kₕₒᵣ, Kᵥₑᵣ, S refer to number of output channels, number of input channels, kernel size in the horizontal direction, kernel size in the vertical direction, and stride of a convolutional layer, respectively. Compared with (a), (b) includes a skip connection at the end, i.e. the input to Layer₁ (which is also the input to Layer₂) is added to the output of Layer₈. It would be appreciated that the numbers of the layers in FIGS. 16A and 16B are examples, and there may be other variations.

In some embodiments, within a basic block, a branch comprises a single convolutional layer to receive the input of the basic block and a single activation layer to receive an output of the single convolutional layer. Example of such a basic block can refer to FIG. 16A and FIG. 16B. A single convolutional layer Layer₁ in a branch is configured to receive the input of the basic block, and a single convolutional layer Layer₂ in another branch is also configured to receive the input of the basic block.

In some embodiments, within a basic block, the number of branches is two, examples of which are shown in FIGS. 16A and 16B. In some embodiments, within a basic block, the plurality of layers for serial processing at least comprises two convolutional layers, e.g., Layer₅ and Layer₇ in the basic block of FIG. 16A and/or 16B.

In some embodiments, within a basic block, the plurality of layers for serial processing further comprises two activation layers, e.g., Layer₆ and Layer₈ in the basic block of FIG. 16A and/or 16B.

In some embodiments, within a basic block (e.g., in FIG. 16A and/or FIG. 16B), in case an output of a previous layer is fed into a plurality of next layers, an input to each of the plurality of next layers is the same as the output of the previous layer. In some embodiments, within a basic block, in case outputs of a plurality of previous layers are fed into a next layer, an input to the next layer is a concatenation of the outputs of the plurality of previous layers along a channel dimension.

The activation layers in a basic block (e.g., in FIG. 16A and/or FIG. 16B) may be configured in any flexible manner.

In some embodiments, at least one of the activation layers comprised in a basic block is configured as a non-linear function. In some embodiments, at least one of the activation layers comprised in a basic block is configured as a linear function.

In some embodiments, at least one activation layer comprised in the plurality of branches is configured as a parametric rectified linear unit (PReLU). In one example, Layer₃ and/or Layer₄ (i.e. f₄ and/or f₂) in FIG. 16A and/or FIG. 16B are PReLU.

In some embodiments, at least one activation layer comprised in the plurality of branches is configured as a Leaky Rectified Linear Unit (LReLU). In one example, Layer₃ and/or Layer₄ (i.e. f₁ and/or f₂) in FIG. 16A and/or FIG. 16B are LReLU.

In some embodiments, at least one activation layer comprised in the plurality of branches is configured as Rectified Linear Unit (ReLU). In one example, Layer₃ and/or Layer₄ (i.e. f₁ and/or f₂) in FIG. 16A and/or FIG. 16B are ReLU.

In some embodiments, at least one activation layer comprised in the plurality of layers is configured as an identity mapping function, which means that the output and input of the layer are exactly the same. In one example, Layer₆ and/or Layer₈ (i.e. f₃ and/or f₄) in FIG. 16A and/or FIG. 16B are identity mapping functions (output and input of the layer are exactly the same).

In some embodiments, at least one activation layer comprised in the plurality of layers is configured as a PReLU. In one example, Layer₆ and/or Layer₈ (i.e. f₃ and/or f₄) in FIG. 16A and/or FIG. 16B are PReLU.

In some embodiments, at least one activation layer comprised in the plurality of layers is configured as a LReLU. In one example, Layer₆ and/or Layer₈ (i.e. f₃ and/or f₄) in FIG. 16A and/or FIG. 16B are LReLU.

In some embodiments, at least one activation layer comprised in the plurality of layers is configured as a ReLU. In one example, Layer₆ and/or Layer₈ (i.e. f₃ and/or f₄) in FIG. 16A and/or FIG. 16B are ReLU.

In one example, all the activation layers in FIG. 16A and/or FIG. 16B are PReLU (Parametric Rectified Linear Unit). In one example, all the activation layers in FIG. 16A and/or FIG. 16B are LReLU (Leaky Rectified Linear Unit). In one example, all the activation layers in FIG. 16A and/or FIG. 16B are ReLU (Rectified Linear Unit).

In some embodiments, at least one activation layer comprised in the plurality of branches is configured as a non-linear function, and at least one activation layer comprised in the plurality of layers is configured as a linear function. In one example, Layer₃ and/or Layer₄ (i.e. f₁ and/or f₂) in FIG. 16A and/or FIG. 16B are non-linear functions while Layer₆ and/or Layer₈ (i.e. f₃ and/or f₄) in FIG. 16A and/or FIG. 16B are linear functions.

In some embodiments, at least one activation layer comprised in the plurality of branches is configured as a non-linear function, and at least one activation layer comprised in the plurality of layers is configured as an identity mapping function. In one example, Layer₃ and/or Layer₄ (i.e. f₁ and/or f₂) in FIG. 16A and/or FIG. 16B are non-linear functions while Layer₆ and/or Layer₈ (i.e. f₃ and/or f₄) in FIG. 16A and/or FIG. 16B are identity mapping functions. In some embodiments, at least one activation layer comprised in the plurality of branches is configured as a parametric rectified linear unit (PReLU) and at least one activation layer comprised in the plurality of layers is configured as an identity mapping function. In one example, Layer₃ and Layer₄ (i.e. f₁ and f₂) in FIG. 16A and FIG. 16B are PReLU (Parametric Rectified Linear Unit) while Layer₆ and Layer₈ (i.e. f₃ and f₄) in FIG. 16A and FIG. 16B are identity mapping functions.

In one example, regarding the actuation layers in the basic block, which configuration to be used may be determined by decoded information. In one example, regarding the actuation layers in the basic block, which configuration to be used may be determined by at least one syntax element signaled from encoder to decoder.

The convolutional layers in a basic block (e.g., in FIG. 16A and/or FIG. 16B) may be configured in any flexible manner.

In some embodiments, convolutional layers comprised in a basic block are configured with the same kernel size. In one example, kernel sizes in all layers are the same, e.g. 1×1, 3×3, 5×5, etc. In some embodiments, convolutional layers comprised in a basic block are configured with different kernel sizes.

In some embodiments, convolutional layers comprised in the plurality of branches of a basic block are configured with different kernel sizes, and convolutional layers comprised in the plurality of layers of the basic block are configured with the same kernel size. In one example, kernel sizes in Layer₁ and Layer₂ are different while kernel sizes in Layer₅ and Layer₇ are the same.

In some embodiments, if two branches are comprised in a basic block, each comprising one convolutional layer, and the plurality of layers of the basic block comprise two convolutional layers, the two convolutional layers comprised in the two branches are configured with kernel sizes of 1×1 and 3×3, respectively, and the two convolutional layers comprised in the plurality of layers are both configured with a kernel size of 3×3. In one example, kernel sizes in Layer₁ and Layer₂ in FIG. 16A and/or FIG. 16B are 1×1 and 3×3 respectively, while kernel sizes in Layer₅ and Layer₇ in FIG. 16A and/or FIG. 16B are both 3×3. In one example, kernel sizes in Layer₁ and Layer₂ are 3×3 and 1×1 respectively, while kernel sizes in Layer₅ and Layer₇ are both 3×3.

In some embodiments, the two convolutional layers comprised in the two branches are configured with kernel sizes of 1×1 and 5×5, respectively, and the two convolutional layers comprised in the plurality of layers are both configured with a kernel size of 3×3. In one example, kernel sizes in Layer₁ and Layer₂ in FIG. 16A and/or FIG. 16B are 1×1 and 5×5 respectively, while kernel sizes in Layer⁵ and Layer₇ in FIG. 16A and/or FIG. 16B are both 3×3. In one example, kernel sizes in Layer₁ and Layer₂ are 5×5 and 1×1 respectively, while kernel sizes in Layer₅ and Layer₇ are both 3×3.

In some embodiments, convolutional layers comprised in the plurality of branches of a basic block are configured with different kernel sizes, and convolutional layers comprised in the plurality of layers of the basic block are configured with different kernel sizes. In one example, kernel sizes in Layer₁ and Layer₂ are different, and kernel sizes in Layer₅ and Layer₇ are also different.

In some embodiments, if two branches are comprised in a basic block, each comprising one convolutional layer, and the plurality of layers of the basic block comprise two convolutional layers, the two convolutional layers comprised in the two branches are configured with kernel sizes of 1 xi and 3×3, respectively, and the two convolutional layers comprised in the plurality of layers are both configured with kernel sizes of 1×1 and 3×3, respectively. In one example, kernel sizes in Layer₁ and Layer₂ in FIG. 16A and/or FIG. 16B are 1×1 and 3×3 respectively, and kernel sizes in Layer₅ and Layer₇ are 1×1 and 3×3 respectively. In one example, kernel sizes in Layer₁ and Layer₂ in FIG. 16A and/or FIG. 16B are 3×3 and 1×1 respectively, and kernel sizes in Layer₅ and Layer₇ are 1×1 and 3×3 respectively.

In some embodiments, the numbers of output channels in convolutional layers comprised in a basic block are the same. In one example, numbers of output channels (a.k.a. output feature maps) in all layers are the same, e.g. 32, 64, 96, 128, etc. In some embodiments, the numbers of output channels in convolutional layers comprised in a basic block are different, for example, the numbers of output channels in all layers are different.

In some embodiments, the numbers of output channels in convolutional layers comprised in the plurality of branches of a basic block are different, and the numbers of output channels in convolutional layers comprised in the plurality of layers of the basic block are the same. In one example, numbers of output channels in Layer₁ and Layer₂ in FIG. 16A and/or FIG. 16B are different while numbers of output channels in Layer₅ and Layer₇ are the same. In one example, the number of output channels in Layer₁ is larger than that in Layer₂. In one example, the number of output channels in Layer₁ is smaller than that in Layer₂.

In some embodiments, the numbers of output channels in convolutional layers comprised in the plurality of branches of a basic block are different, and the numbers of output channels in convolutional layers comprised in the plurality of layers of the basic block are different. In one example, numbers of output channels in Layer₁ and Layer₂ in FIG. 16A and/or FIG. 16B are different, and numbers of output channels in Layer₅ and Layer₇ in FIG. 16A and/or FIG. 16B are also different. In one example, the number of output channels in Layer₁ is larger than that in Layer₂, and the number of output channels in Layer₅ is larger than that in Layer₇. In one example, the number of output channels in Layer₁ is smaller than that in Layer₂, and the number of output channels in Layer₅ is larger than that in Layer₇.

In some embodiments, convolutional layers comprised in the plurality of branches of a basic block are configured with different kernel sizes and with different numbers of output channels; and wherein convolutional layers comprised in the plurality of layers of the basic block are configured with different kernel sizes and with the same numbers of output channel. In one example, kernel sizes in Layer₁ and Layer₂ are different, kernel sizes in Layer₅ and Layer₇ in FIG. 16A and/or FIG. 16B are different, numbers of output channels in Layer₁ and Layer₂ in FIG. 16A and/or FIG. 16B are different, the numbers of output channels in Layer₅ and Layer₇ in FIG. 16A and/or FIG. 16B are the same.

In some embodiments, two branches are comprised in a basic block, each comprising one convolutional layer, and the plurality of layers of the basic block comprise two convolutional layers. The number of input channels to two convolutional layers comprised in two branches of the basic block is denoted as N. The numbers of output channels in the two convolutional layers comprised in the two branches are set as N×C₁ and N×C₂, respectively, where C₁ is greater than 1.0 and C₂ is smaller than 1.0, the numbers of output channels in the two convolutional layers comprised in the plurality of layers are set as N, and the kernel sizes in the two convolutional layers comprised in the two branches are 1×1 and 3×3 respectively, and the kernel sizes in the two convolutional layers comprised in the plurality of layers are set as 1×1 and 3×3 respectively. For example, the number of input channels to Layer₁ (which is also the input channels to Layer₂) is denoted as N. Numbers of output channels in Layer₁ and Layer₂ are set as N×C₁ and N×C₂, respectively, where C₁ is greater than 1.0 (e.g. 2.5) and C₂ is smaller than 1.0 (e.g. 0.5). Numbers of output channels in Layer₅ and Layer₇ are both set as N. Kernel sizes in Layer₁ and Layer₂ are 1×1 and 3×3 respectively, and kernel sizes in Layer⁵ and Layer₇ are set as 1×1 and 3×3 respectively.

In some embodiments, two branches are comprised in a basic block, each comprising one convolutional layer, the plurality of layers of the basic block comprise two convolutional layers, and the number of input channels to two convolutional layers comprised in two branches of the basic block is denoted as N, the numbers of output channels in the two convolutional layers comprised in the two branches are set as N×C₁ and N×C₂, respectively, where C₁ is smaller than 1.0 and C₂ is greater than 1.0, the numbers of output channels in the two convolutional layers comprised in the plurality of layers are set as N; and the kernel sizes in the two convolutional layers comprised in the two branches are 1×1 and 3×3 respectively, and the kernel sizes in the two convolutional layers comprised in the plurality of layers are set as 1×1 and 3×3 respectively. For example, the number of input channels to Layer₁ (which is also the input channels to Layer₂) is denoted as N. Numbers of output channels in Layer₁ and Layer₂ are set as N×C₁ and N×C₂, respectively, where C₁ is smaller than 1.0 (e.g. 0.5) and C₂ is greater than 1.0 (e.g. 2.5). Numbers of output channels in Layer₅ and Layer₇ are both set as N. Kernel sizes in Layer₁ and Layer₂ are 1×1 and 3×3 respectively, and kernel sizes in Layer⁵ and Layer₇ are set as 1×1 and 3×3 respectively.

In some embodiments, two branches are comprised in a basic block, each comprising one convolutional layer, and the plurality of layers of the basic block comprise two convolutional layers, the numbers of output channels in the two convolutional layers comprised in the two branches are set as N×C₁ and N×C₂, respectively, where N is an integer number, C₁ is greater than 1.0 and C₂ is smaller than 1.0; and the numbers of output channels in the two convolutional layers comprised in the plurality of layers are both set as N; and the kernel sizes in the two convolutional layers comprised in the two branches are 1×1 and 3×3 respectively, and the kernel sizes in the two convolutional layers comprised in the plurality of layers are set as 1×1 and 3×3 respectively. For example, given an integer number N (e.g. 32, 64, 96, 128, etc.), numbers of output channels in Layer₁ and Layer₂ are set as N×C₁ and N×C₂, respectively, where C₁ is greater than 1.0 (e.g. 2.5) and C₂ is smaller than 1.0 (e.g. 0.5). Numbers of output channels in Layer₅ and Layer₇ are both set as N. Kernel sizes in Layer₁ and Layer₂ are 1×1 and 3×3 respectively, and kernel sizes in Layer₅ and Layer₇ are set as 1×1 and 3×3 respectively.

In some embodiments, two branches are comprised in a basic block, each comprising one convolutional layer, and the plurality of layers of the basic block comprise two convolutional layers, the numbers of output channels in the two convolutional layers comprised in the two branches are set as N×C₁ and N×C₂, respectively, where N is an integer number, C₁ is smaller than 1.0 and C₂ is greater than 1.0; the numbers of output channels in the two convolutional layers comprised in the plurality of layers are set as N; and the kernel sizes in the two convolutional layers comprised in the two branches are 1×1 and 3×3 respectively, and the kernel sizes in the two convolutional layers comprised in the plurality of layers are set as 1×1 and 3×3 respectively. For example, given an integer number N (e.g. 32, 64, 96, 128, etc.), numbers of output channels in Layer₁ and Layer₂ are set as N×C₁ and N×C₂, respectively, where C₁ is smaller than 1.0 (e.g. 0.5) and C₂ is greater than 1.0 (e.g. 2.5). Numbers of output channels in Layer₅ and Layer₇ are both set as N. Kernel sizes in Layer₁ and Layer₂ are 1×1 and 3×3 respectively, and kernel sizes in Layer₅ and Layer₇ are set as 1×1 and 3×3 respectively.

In some embodiments, a configuration related to the plurality of branches in a basic block, a configuration related to the plurality of layers in a basic block, a configuration related to the activation layers in a basic block, and/or a configuration related to the convolutional layers in a basic block are determined based on at least one of the following: decoded information of the video, or at least one syntax element signaled from an encoder of the video to a decoder of the video.

In some embodiments, the configurations related to the activation layers and the configurations related to the convolutional layers as discussed above may be combined. Specifically, the activation layers may be configured in any of the above embodiments while the convolutional layers may be configured using any of the above embodiments.

The activation layers and the convolutional layers shown in FIGS. 16A-16B may be jointly configured in certain manners to achieve better performance.

In some embodiments, within a basic block, activation layers comprised in the plurality of branches of the basic block are configured as non-linear functions, and activation layers comprised in the plurality of layers of the basic block are configured as identity mapping functions; and convolutional layers comprised in the plurality of branches of the basic block are configured with different kernel sizes, and convolutional layers comprised in the plurality of layers of the basic block are configured with different kernel sizes; and the numbers of output channels in convolutional layers comprised in the plurality of branches of a basic block are different, and the numbers of output channels in convolutional layers comprised in the plurality of layers of the basic block are the same. In one example, Layer₃ and Layer₄ (i.e. f₁ and f₂) in FIG. 16A and/or FIG. 16B are non-linear functions while Layer₆ and Layer₈ (i.e. f₃ and f₄) in FIG. 16A and/or FIG. 16B are identity mapping functions. Kernel sizes in Layer₁ and Layer₂ are different, kernel sizes in Layer₅ and Layer₇ are different, numbers of output channels in Layer₁ and Layer₂ are different, numbers of output channels in Layer₅ and Layer₇ are the same.

In some embodiments, the activation layers comprised in the plurality of branches of the basic block are configured as at least one of the following: parametric rectified linear units (PReLUs), Leaky Rectified Linear Units (LReLUs), or Rectified Linear Units (ReLUs). In one example, Layer₃ and Layer₄ (i.e. f₁ and f₂) in FIG. 16A and FIG. 16B are PReLU (Parametric Rectified Linear Unit). In one example, Layer₃ and Layer₄ (i.e. f₁ and f₂) in FIG. 16A and FIG. 16B are LReLU (Leaky Rectified Linear Unit). In one example, Layer₃ and Layer₄ (i.e. f₁ and f₂) in FIG. 16A and FIG. 16B are ReLU (Rectified Linear Unit).

In some embodiments, among the plurality of branches of the basic block, a kernel size in a first convolutional layer comprised in a first branch is smaller than a kernel size in a second convolutional layer comprised in a second branch, and a first number of output channels in the first convolutional layer is larger than a second number of output channels in the second convolutional layer, and among the plurality of layers of the basic block, a kernel size in a previous convolutional layer is smaller than a kernel size in a following convolutional layer. In one example, kernel size in Layer₁ is smaller than that in Layer₂, kernel size in Layer₅ is smaller than that in Layer₇, number of output channels in Layer₁ is larger than that in Layer₂.

In some embodiments, among the plurality of branches of the basic block, a kernel size in the first convolutional layer comprised in the first branch is larger than a kernel size in the second convolutional layer comprised in the second branch, and the first number of output channels in the first convolutional layer is smaller than the second number of output channels in the second convolutional layer, and among the plurality of layers of the basic block, a kernel size in a previous convolutional layer is smaller than a kernel size in a following convolutional layer. In one example, kernel size in Layer₁ is larger than that in Layer₂, kernel size in Layer₅ is smaller than that in Layer₇, number of output channels in Layer₁ is smaller than that in Layer₂.

In some embodiments, the at least one basic block comprised in the NN model comprises at least one basic block of a first type and/or at least one basic block of a second type, where a basic block of the first type having no skip connection to add an input to the basic block to the output of a last layer of the basic block; and wherein a basic block of the second type has a skip connection to add an input to the basic block to the output of a last layer of the basic block. For example, the NN model may comprise one or more basic blocks shown in FIGS. 16A-16B. In one example, the NN model comprises at least one basic block shown in FIG. 16A. In one example, the NN model comprises at least one basic block shown in FIG. 16B. In one example, the NN model comprises at least one basic block shown in FIG. 16A and at least one basic block shown in FIG. 16B.

In some embodiments, the NN model comprises a head part, a backbone part, and a tail part, wherein the head part is configured for extracting features from an input to the NN model, the backbone part is configured for further feature mapping, and the tail part is configured for transforming output features of the backbone part into an output of the NN model. The NN model may contain three parts as the architecture 1700 shown in FIG. 17, where the head part is responsible for extracting features from the input to the NN model, which are then fed into the backbone part for further feature mapping. The tail part transforms the output features of backbone part into the final output.

In some embodiments, at least one of the head part, the backbone part, or the tail part each comprises a first number of basis blocks of the first type that are connected in series. An example is shown in FIG. 18, which includes a stack of basic blocks 1800, where BasicBlockTypeA is the basic block shown in FIG. 16A, and Ma is the number of stacked blocks.

In some embodiments, at least one of the head part, the backbone part, or the tail part each comprises a second number of basis blocks of the second type that are connected in series. An example is shown in FIG. 19, which includes a stack of basic blocks 1900, where BasicBlockTypeB is the block shown in FIG. 16B, and Mb is the number of stacked blocks. Mb may be set as any suitable number.

In some embodiments, at least one of the head part, the backbone part, or the tail part each comprises a first number of basis blocks of the first type that are connected in series, following a second number of basis blocks of the second type that are connected in series. An example is shown in FIG. 20, which includes a stack of basic blocks 2000, where BasicBlockTypeA is the block shown in FIG. 16A, and BasicBlockTypeB is the block shown in FIG. 16B. Ma and Mb are the numbers of stacked blocks, which may be set as any suitable numbers.

In some embodiments, at least one of the head part, the backbone part, or the tail part each comprises a second number of basis blocks of the second type that are connected in series, following a first number of basis blocks of the first type that are connected in series. An example is shown in FIG. 21, which includes a stack of basic blocks 2100, where BasicBlockTypeB is the block shown in FIG. 16B, and BasicBlockTypeA is the block shown in FIG. 16A. Mb and Ma are the numbers of stacked blocks, which may be set as any suitable numbers.

In one example, the head part is designed in the way shown in FIG. 18. In one example, the head part is designed in the way shown in FIG. 19. In one example, the head part is designed in the way shown in FIG. 20. In one example, the head part is designed in the way shown in FIG. 21.

Similarly, in one example, the backbone part is designed in the way shown in FIG. 18. In one example, the backbone part is designed in the way shown in FIG. 19. In one example, the backbone part is designed in the way shown in FIG. 20. In one example, the backbone part is designed in the way shown in FIG. 21. The numbers of the basic blocks Ma and/or Mb in the backbone part may be the same or different from those in the head part or the tail part.

Similarly, in one example, the tail part is designed in the way shown in FIG. 18. In one example, the tail part is designed in the way shown in FIG. 19. In one example, the tail part is designed in the way shown in FIG. 20. In one example, the tail part is designed in the way shown in FIG. 21. The numbers of the basic blocks Ma and/or Mb in the tail part may be the same or different from those in the head part or the backbone part.

In some embodiments, the head part comprises a second number of basis blocks of the second type that are connected in series, the backbone part comprises the second number of basis blocks of the second type that are connected in series, following a first number of basis blocks of the first type that are connected in series, and the tail part comprises a regular convolutional layer. In one example, the head part is designed in the way shown in FIG. 18, the backbone part is designed in the way shown in FIG. 21, and the tail part is a regular convolutional layer.

In some embodiments, integer operations are applied in the NN model. For example, only integer operations may be applied in the proposed architectures. In some embodiments, no floating-point operations are applied in the NN model. In some embodiments, no division operations are applied in the NN model.

In some embodiments, the integer operations applied in the NN model comprises at least one of the following: an adding operation, a multiplying operation, a shifting operation, a rounding operation, and a clipping operation, etc.

According to further embodiments of the present disclosure, a non-transitory computer-readable recording medium is provided. The non-transitory computer-readable recording medium stores a bitstream of a video which is generated by a method performed by an apparatus for video processing.

The method comprises: obtaining a neural network (NN) model for processing a video, the NN model comprising at least one basic block, wherein a basic block comprises: a plurality of branches for parallel processing an input of the basic block, a branch comprising at least one convolutional layer and at least one activation layer, and a plurality of layers for serial processing a combination of outputs of the plurality of branch, the plurality of layers comprising at least one convolutional layer and at least one activation layer; and generating a bitstream of the video according to the NN model.

According to still further embodiments of the present disclosure, a method for storing bitstream of a video is provided. The method comprises: obtaining a neural network (NN) model for processing a video, the NN model comprising at least one basic block, wherein a basic block comprises: a plurality of branches for parallel processing an input of the basic block, a branch comprising at least one convolutional layer and at least one activation layer, and a plurality of layers for serial processing a combination of outputs of the plurality of branch, the plurality of layers comprising at least one convolutional layer and at least one activation layer; generating a bitstream of the video according to the NN model; and storing the bitstream in a non-transitory computer-readable recording medium.

Implementations of the present disclosure can be described in view of the following clauses, the features of which can be combined in any reasonable manner.

Clause 1. A method for video processing, comprising: obtaining a neural network (NN) model for processing a video, the NN model comprising at least one basic block, wherein a basic block comprises: a plurality of branches for parallel processing an input of the basic block, a branch comprising at least one convolutional layer and at least one activation layer, and a plurality of layers for serial processing a combination of outputs of the plurality of branch, the plurality of layers comprising at least one convolutional layer and at least one activation layer; and performing, according to the NN model, a conversion between a current video block of the video and a bitstream of the video.

Clause 2. The method of clause 1, wherein within a basic block, a branch comprises a single convolutional layer to receive the input of the basic block and a single activation layer to receive an output of the single convolutional layer.

Clause 3. The method of clause 1 or 2, wherein within a basic block, the number of branches is two; and/or wherein within a basic block, the plurality of layers for serial processing at least comprises two convolutional layers; and/or wherein within a basic block, the plurality of layers for serial processing further comprises two activation layers.

Clause 4. The method of any of clauses 1 to 3, wherein within a basic block, in case an output of a previous layer is fed into a plurality of next layers, an input to each of the plurality of next layers is the same as the output of the previous layer.

Clause 5. The method of any of clauses 1 to 4, wherein within a basic block, in case outputs of a plurality of previous layers are fed into a next layer, an input to the next layer is a concatenation of the outputs of the plurality of previous layers along a channel dimension.

Clause 6. The method of any of clauses 1 to 5, wherein at least one activation layer comprised in a basic block is configured as at least one of the following: a non-linear function, or a linear function; and/or wherein at least one activation layer comprised in the plurality of branches is configured as at least one of the following: a parametric rectified linear unit (PReLU), a Leaky Rectified Linear Unit (LReLU), or a Rectified Linear Unit (ReLU); and/or wherein at least one activation layer comprised in the plurality of layers is configured as at least one of the following: an identity mapping function, a PReLU, a LReLU, or a ReLU.

Clause 7. The method of any of clauses 1 to 6, wherein at least one activation layer comprised in the plurality of branches is configured as a non-linear function, and at least one activation layer comprised in the plurality of layers is configured as a linear function; and/or wherein at least one activation layer comprised in the plurality of branches is configured as a non-linear function, and at least one activation layer comprised in the plurality of layers is configured as an identity mapping function; and/or wherein at least one activation layer comprised in the plurality of branches is configured as a parametric rectified linear unit (PReLU) and at least one activation layer comprised in the plurality of layers is configured as an identity mapping function.

Clause 8. The method of any of clauses 1 to 7, wherein convolutional layers comprised in a basic block are configured with the same kernel size, or wherein convolutional layers comprised in a basic block are configured with different kernel sizes, or wherein convolutional layers comprised in the plurality of branches of a basic block are configured with different kernel sizes, and convolutional layers comprised in the plurality of layers of the basic block are configured with the same kernel size, or wherein convolutional layers comprised in the plurality of branches of a basic block are configured with different kernel sizes, and convolutional layers comprised in the plurality of layers of the basic block are configured with different kernel sizes.

Clause 9. The method of clause 8, wherein two branches are comprised in a basic block, each comprising one convolutional layer, and the plurality of layers of the basic block comprise two convolutional layers; and wherein the two convolutional layers comprised in the two branches are configured with kernel sizes of 1×1 and 3×3, respectively, and the two convolutional layers comprised in the plurality of layers are both configured with a kernel size of 3×3; or wherein the two convolutional layers comprised in the two branches are configured with kernel sizes of 1×1 and 5×5, respectively, and the two convolutional layers comprised in the plurality of layers are both configured with a kernel size of 3×3.

Clause 10. The method of clause 8, wherein two branches are comprised in a basic block, each comprising one convolutional layer, and the plurality of layers of the basic block comprise two convolutional layers; and wherein the two convolutional layers comprised in the two branches are configured with kernel sizes of 1×1 and 3×3, respectively, and the two convolutional layers comprised in the plurality of layers are both configured with kernel sizes of 1×1 and 3×3, respectively.

Clause 11. The method of any of clauses 1 to 10, wherein the numbers of output channels in convolutional layers comprised in a basic block are the same; or wherein the numbers of output channels in convolutional layers comprised in a basic block are different; or wherein the numbers of output channels in convolutional layers comprised in the plurality of branches of a basic block are different, and the numbers of output channels in convolutional layers comprised in the plurality of layers of the basic block are the same; or wherein the numbers of output channels in convolutional layers comprised in the plurality of branches of a basic block are different, and the numbers of output channels in convolutional layers comprised in the plurality of layers of the basic block are different.

Clause 12. The method of any of clauses 1 to 11, wherein convolutional layers comprised in the plurality of branches of a basic block are configured with different kernel sizes and with different numbers of output channels; and wherein convolutional layers comprised in the plurality of layers of the basic block are configured with different kernel sizes and with the same numbers of output channel.

Clause 13. The method of clause 12, wherein two branches are comprised in a basic block, each comprising one convolutional layer, the plurality of layers of the basic block comprise two convolutional layers, and the number of input channels to two convolutional layers comprised in two branches of the basic block is denoted as N, the numbers of output channels in the two convolutional layers comprised in the two branches are set as N×C₁ and N×C₂, respectively, where C₁ is greater than 1.0 and C₂ is smaller than 1.0, the numbers of output channels in the two convolutional layers comprised in the plurality of layers are set as N, and the kernel sizes in the two convolutional layers comprised in the two branches are 1×1 and 3×3 respectively, and the kernel sizes in the two convolutional layers comprised in the plurality of layers are set as 1×1 and 3×3 respectively.

Clause 14. The method of clause 12, wherein two branches are comprised in a basic block, each comprising one convolutional layer, the plurality of layers of the basic block comprise two convolutional layers, and the number of input channels to two convolutional layers comprised in two branches of the basic block is denoted as N, the numbers of output channels in the two convolutional layers comprised in the two branches are set as N×C₁ and N×C₂, respectively, where C₁ is smaller than 1.0 and C₂ is greater than 1.0, the numbers of output channels in the two convolutional layers comprised in the plurality of layers are set as N; and the kernel sizes in the two convolutional layers comprised in the two branches are 1×1 and 3×3 respectively, and the kernel sizes in the two convolutional layers comprised in the plurality of layers are set as 1×1 and 3×3 respectively.

Clause 15. The method of clause 12, wherein two branches are comprised in a basic block, each comprising one convolutional layer, and the plurality of layers of the basic block comprise two convolutional layers, the numbers of output channels in the two convolutional layers comprised in the two branches are set as N×C₁ and N×C₂, respectively, where N is an integer number, C₁ is greater than 1.0 and C₂ is smaller than 1.0; and the numbers of output channels in the two convolutional layers comprised in the plurality of layers are both set as N; and the kernel sizes in the two convolutional layers comprised in the two branches are 1×1 and 3×3 respectively, and the kernel sizes in the two convolutional layers comprised in the plurality of layers are set as 1×1 and 3×3 respectively.

Clause 16. The method of clause 12, wherein two branches are comprised in a basic block, each comprising one convolutional layer, and the plurality of layers of the basic block comprise two convolutional layers, the numbers of output channels in the two convolutional layers comprised in the two branches are set as N×C₁ and N×C₂, respectively, where N is an integer number, C₁ is smaller than 1.0 and C₂ is greater than 1.0; the numbers of output channels in the two convolutional layers comprised in the plurality of layers are set as N; and the kernel sizes in the two convolutional layers comprised in the two branches are 1×1 and 3×3 respectively, and the kernel sizes in the two convolutional layers comprised in the plurality of layers are set as 1×1 and 3×3 respectively.

Clause 17. The method of any of clauses 1 to 16, wherein a configuration related to the plurality of branches in a basic block, a configuration related to the plurality of layers in a basic block, a configuration related to the activation layers in a basic block, and/or a configuration related to the convolutional layers in a basic block are determined based on at least one of the following: decoded information of the video, or at least one syntax element signaled from an encoder of the video to a decoder of the video.

Clause 18. The method of any of clauses 1 to 17, wherein within a basic block, activation layers comprised in the plurality of branches of the basic block are configured as non-linear functions, and activation layers comprised in the plurality of layers of the basic block are configured as identity mapping functions; and convolutional layers comprised in the plurality of branches of the basic block are configured with different kernel sizes, and convolutional layers comprised in the plurality of layers of the basic block are configured with different kernel sizes; and the numbers of output channels in convolutional layers comprised in the plurality of branches of a basic block are different, and the numbers of output channels in convolutional layers comprised in the plurality of layers of the basic block are the same.

Clause 19. The method of clause 18, wherein the activation layers comprised in the plurality of branches of the basic block are configured as at least one of the following: parametric rectified linear units (PReLUs), Leaky Rectified Linear Units (LReLUs), or Rectified Linear Units (ReLUs); and/or wherein among the plurality of branches of the basic block, a kernel size in a first convolutional layer comprised in a first branch is smaller than a kernel size in a second convolutional layer comprised in a second branch, and a first number of output channels in the first convolutional layer is larger than a second number of output channels in the second convolutional layer, and among the plurality of layers of the basic block, a kernel size in a previous convolutional layer is smaller than a kernel size in a following convolutional layer; or wherein among the plurality of branches of the basic block, a kernel size in the first convolutional layer comprised in the first branch is larger than a kernel size in the second convolutional layer comprised in the second branch, and the first number of output channels in the first convolutional layer is smaller than the second number of output channels in the second convolutional layer, and among the plurality of layers of the basic block, a kernel size in a previous convolutional layer is smaller than a kernel size in a following convolutional layer.

Clause 20. The method of any of clauses 1 to 19, wherein the at least one basic block comprised in the NN model comprises at least one basic block of a first type and/or at least one basic block of a second type; wherein a basic block of the first type having no skip connection to add an input to the basic block to the output of a last layer of the basic block; and wherein a basic block of the second type has a skip connection to add an input to the basic block to the output of a last layer of the basic block.

Clause 21. The method of any of clauses 1 to 20, wherein the NN model comprises a head part, a backbone part, and a tail part, wherein the head part is configured for extracting features from an input to the NN model, the backbone part is configured for further feature mapping, and the tail part is configured for transforming output features of the backbone part into an output of the NN model.

Clause 22. The method of clause 21, wherein at least one of the head part, the backbone part, or the tail part each comprises a first number of basis blocks of the first type that are connected in series; or wherein at least one of the head part, the backbone part, or the tail part each comprises a second number of basis blocks of the second type that are connected in series; or wherein at least one of the head part, the backbone part, or the tail part each comprises a first number of basis blocks of the first type that are connected in series, following a second number of basis blocks of the second type that are connected in series; or wherein at least one of the head part, the backbone part, or the tail part each comprises a second number of basis blocks of the second type that are connected in series, following a first number of basis blocks of the first type that are connected in series; or wherein the head part comprises a second number of basis blocks of the second type that are connected in series, the backbone part comprises the second number of basis blocks of the second type that are connected in series, following a first number of basis blocks of the first type that are connected in series, and the tail part comprises a regular convolutional layer.

Clause 23. The method of any of clauses 1 to 22, wherein integer operations are applied in the NN model; and wherein no floating-point operations are applied in the NN model; and wherein no division operations are applied in the NN model; and/or wherein the integer operations applied in the NN model comprises at least one of the following: an adding operation, a multiplying operation, a shifting operation, a rounding operation, and a clipping operation.

Clause 24. An apparatus for processing video data comprising a processor and a non-transitory memory with instructions thereon, wherein the instructions upon execution by the processor, cause the processor to perform a method in accordance with any of clauses 1-23.

Clause 25. A non-transitory computer-readable storage medium storing instructions that cause a processor to perform a method in accordance with any of clauses 1-23.

Clause 26. A non-transitory computer-readable recording medium storing a bitstream of a video which is generated by a method performed by a video processing apparatus, wherein the method comprises: obtaining a neural network (NN) model for processing a video, the NN model comprising at least one basic block, wherein a basic block comprises: a plurality of branches for parallel processing an input of the basic block, a branch comprising at least one convolutional layer and at least one activation layer, and a plurality of layers for serial processing a combination of outputs of the plurality of branch, the plurality of layers comprising at least one convolutional layer and at least one activation layer; and generating a bitstream of the video according to the NN model.

Clause 27. A method for storing a bitstream of a video, comprising: obtaining a neural network (NN) model for processing a video, the NN model comprising at least one basic block, wherein a basic block comprises: a plurality of branches for parallel processing an input of the basic block, a branch comprising at least one convolutional layer and at least one activation layer, and a plurality of layers for serial processing a combination of outputs of the plurality of branch, the plurality of layers comprising at least one convolutional layer and at least one activation layer; generating a bitstream of the video according to the NN model; and storing the bitstream in a non-transitory computer-readable recording medium.

### Example Device

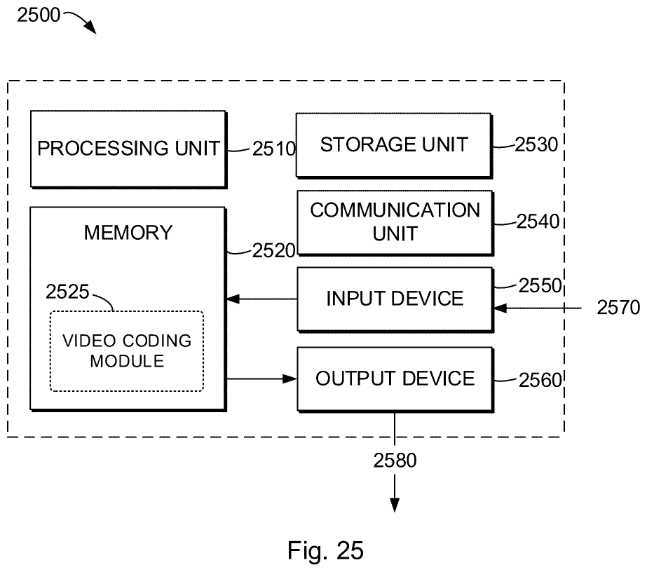

FIG. 25 illustrates a block diagram of a computing device 2500 in which various embodiments of the present disclosure can be implemented. The computing device 2500 may be implemented as or included in the source device 110 (or the video encoder 114 or 200) or the destination device 120 (or the video decoder 124 or 300).

It would be appreciated that the computing device 2500 shown in FIG. 25 is merely for purpose of illustration, without suggesting any limitation to the functions and scopes of the embodiments of the present disclosure in any manner.

As shown in FIG. 25, the computing device 2500 includes a general-purpose computing device 2500. The computing device 2500 may at least comprise one or more processors or processing units 2510, a memory 2520, a storage unit 2530, one or more communication units 2540, one or more input devices 2550, and one or more output devices 2560.

In some embodiments, the computing device 2500 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2500 can support any type of interface to a user (such as “wearable” circuitry and the like).

The processing unit 2510 may be a physical or virtual processor and can implement various processes based on programs stored in the memory 2520. In a multi-processor system, multiple processing units execute computer executable instructions in parallel so as to improve the parallel processing capability of the computing device 2500. The processing unit 2510 may also be referred to as a central processing unit (CPU), a microprocessor, a controller or a microcontroller.

The computing device 2500 typically includes various computer storage medium. Such medium can be any medium accessible by the computing device 2500, including, but not limited to, volatile and non-volatile medium, or detachable and non-detachable medium. The memory 2520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2530 may be any detachable or non-detachable medium and may include a machine-readable medium such as a memory, flash memory drive, magnetic disk or another other media, which can be used for storing information and/or data and can be accessed in the computing device 2500.

The computing device 2500 may further include additional detachable/non-detachable, volatile/non-volatile memory medium. Although not shown in FIG. 25, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2540 communicates with a further computing device via the communication medium. In addition, the functions of the components in the computing device 2500 can be implemented by a single computing cluster or multiple computing machines that can communicate via communication connections. Therefore, the computing device 2500 can operate in a networked environment using a logical connection with one or more other servers, networked personal computers (PCs) or further general network nodes.

The input device 2550 may be one or more of a variety of input devices, such as a mouse, keyboard, tracking ball, voice-input device, and the like. The output device 2560 may be one or more of a variety of output devices, such as a display, loudspeaker, printer, and the like. By means of the communication unit 2540, the computing device 2500 can further communicate with one or more external devices (not shown) such as the storage devices and display device, with one or more devices enabling the user to interact with the computing device 2500, or any devices (such as a network card, a modem and the like) enabling the computing device 2500 to communicate with one or more other computing devices, if required. Such communication can be performed via input/output (I/O) interfaces (not shown).

In some embodiments, instead of being integrated in a single device, some or all components of the computing device 2500 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2500 may be used to implement video encoding/decoding in embodiments of the present disclosure. The memory 2520 may include one or more video coding modules 2525 having one or more program instructions. These modules are accessible and executable by the processing unit 2510 to perform the functionalities of the various embodiments described herein.

In the example embodiments of performing video encoding, the input device 2550 may receive video data as an input 2570 to be encoded. The video data may be processed, for example, by the video coding module 2525, to generate an encoded bitstream. The encoded bitstream may be provided via the output device 2560 as an output 2580.

In the example embodiments of performing video decoding, the input device 2550 may receive an encoded bitstream as the input 2570. The encoded bitstream may be processed, for example, by the video coding module 2525, to generate decoded video data. The decoded video data may be provided via the output device 2560 as the output 2580.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
obtaining a neural network (NN) model for processing a video, the NN model comprising at least one basic block, wherein a basic block comprises:
a plurality of branches for parallel processing an input of the basic block, a branch comprising at least one convolutional layer and at least one activation layer, and
a plurality of layers for serial processing a combination of outputs of the plurality of branch, the plurality of layers comprising at least one convolutional layer and at least one activation layer; and
performing, according to the NN model, a conversion between a current video block of the video and a bitstream of the video.

2. The method of claim 1, wherein within a basic block, a branch comprises a single convolutional layer to receive the input of the basic block and a single activation layer to receive an output of the single convolutional layer; and/or
wherein within a basic block, the number of branches is two; and/or
wherein within a basic block, the plurality of layers for serial processing at least comprises two convolutional layers; and/or
wherein within a basic block, the plurality of layers for serial processing further comprises two activation layers.

3. The method of claim 1, wherein within a basic block, in case an output of a previous layer is fed into a plurality of next layers, an input to each of the plurality of next layers is the same as the output of the previous layer, and/or
wherein within a basic block, in case outputs of a plurality of previous layers are fed into a next layer, an input to the next layer is a concatenation of the outputs of the plurality of previous layers along a channel dimension.

4. The method of claim 1, wherein at least one activation layer comprised in a basic block is configured as at least one of the following: a non-linear function, or a linear function; and/or
wherein at least one activation layer comprised in the plurality of branches is configured as at least one of the following: a parametric rectified linear unit (PReLU), a Leaky Rectified Linear Unit (LReLU), or a Rectified Linear Unit (ReLU); and/or
wherein at least one activation layer comprised in the plurality of layers is configured as at least one of the following: an identity mapping function, a PReLU, a LReLU, or a ReLU, and/or
wherein at least one activation layer comprised in the plurality of branches is configured as a non-linear function, and at least one activation layer comprised in the plurality of layers is configured as a linear function; and/or
wherein at least one activation layer comprised in the plurality of branches is configured as a non-linear function, and at least one activation layer comprised in the plurality of layers is configured as an identity mapping function; and/or
wherein at least one activation layer comprised in the plurality of branches is configured as a parametric rectified linear unit (PReLU) and at least one activation layer comprised in the plurality of layers is configured as an identity mapping function.

5. The method of claim 1, wherein convolutional layers comprised in a basic block are configured with the same kernel size, or
wherein convolutional layers comprised in a basic block are configured with different kernel sizes, or
wherein convolutional layers comprised in the plurality of branches of a basic block are configured with different kernel sizes, and convolutional layers comprised in the plurality of layers of the basic block are configured with the same kernel size, or
wherein convolutional layers comprised in the plurality of branches of a basic block are configured with different kernel sizes, and convolutional layers comprised in the plurality of layers of the basic block are configured with different kernel sizes.

6. The method of claim 5, wherein two branches are comprised in a basic block, each comprising one convolutional layer, and the plurality of layers of the basic block comprise two convolutional layers; and wherein the two convolutional layers comprised in the two branches are configured with kernel sizes of 1×1 and 3×3, respectively, and the two convolutional layers comprised in the plurality of layers are both configured with a kernel size of 3×3; or wherein the two convolutional layers comprised in the two branches are configured with kernel sizes of 1×1 and 5×5, respectively, and the two convolutional layers comprised in the plurality of layers are both configured with a kernel size of 3×3, or
wherein two branches are comprised in a basic block, each comprising one convolutional layer, and the plurality of layers of the basic block comprise two convolutional layers; and wherein the two convolutional layers comprised in the two branches are configured with kernel sizes of 1×1 and 3×3, respectively, and the two convolutional layers comprised in the plurality of layers are both configured with kernel sizes of 1×1 and 3×3, respectively.

7. The method of claim 1, wherein the numbers of output channels in convolutional layers comprised in a basic block are the same; or
wherein the numbers of output channels in convolutional layers comprised in a basic block are different; or
wherein the numbers of output channels in convolutional layers comprised in the plurality of branches of a basic block are different, and the numbers of output channels in convolutional layers comprised in the plurality of layers of the basic block are the same; or
wherein the numbers of output channels in convolutional layers comprised in the plurality of branches of a basic block are different, and the numbers of output channels in convolutional layers comprised in the plurality of layers of the basic block are different.

8. The method of claim 1, wherein convolutional layers comprised in the plurality of branches of a basic block are configured with different kernel sizes and with different numbers of output channels; and
wherein convolutional layers comprised in the plurality of layers of the basic block are configured with different kernel sizes and with the same numbers of output channel.

9. The method of claim 8, wherein two branches are comprised in a basic block, each comprising one convolutional layer, the plurality of layers of the basic block comprise two convolutional layers, and the number of input channels to two convolutional layers comprised in two branches of the basic block is denoted as N, the numbers of output channels in the two convolutional layers comprised in the two branches are set as N×C₁ and N×C₂, respectively, where C₁ is greater than 1.0 and C₂ is smaller than 1.0, the numbers of output channels in the two convolutional layers comprised in the plurality of layers are set as N, and the kernel sizes in the two convolutional layers comprised in the two branches are 1×1 and 3×3 respectively, and the kernel sizes in the two convolutional layers comprised in the plurality of layers are set as 1×1 and 3×3 respectively, or
wherein two branches are comprised in a basic block, each comprising one convolutional layer, the plurality of layers of the basic block comprise two convolutional layers, and the number of input channels to two convolutional layers comprised in two branches of the basic block is denoted as N, the numbers of output channels in the two convolutional layers comprised in the two branches are set as N×C₁ and N×C₂, respectively, where C₁ is smaller than 1.0 and C₂ is greater than 1.0, the numbers of output channels in the two convolutional layers comprised in the plurality of layers are set as N, and the kernel sizes in the two convolutional layers comprised in the two branches are 1×1 and 3×3 respectively, and the kernel sizes in the two convolutional layers comprised in the plurality of layers are set as 1×1 and 3×3 respectively, or
wherein two branches are comprised in a basic block, each comprising one convolutional layer, and the plurality of layers of the basic block comprise two convolutional layers, the numbers of output channels in the two convolutional layers comprised in the two branches are set as N×C₁ and N×C₂, respectively, where N is an integer number, C₁ is greater than 1.0 and C₂ is smaller than 1.0; and the numbers of output channels in the two convolutional layers comprised in the plurality of layers are both set as N; and the kernel sizes in the two convolutional layers comprised in the two branches are 1×1 and 3×3 respectively, and the kernel sizes in the two convolutional layers comprised in the plurality of layers are set as 1×1 and 3×3 respectively, or
wherein two branches are comprised in a basic block, each comprising one convolutional layer, and the plurality of layers of the basic block comprise two convolutional layers, the numbers of output channels in the two convolutional layers comprised in the two branches are set as N×C₁ and N×C₂, respectively, where N is an integer number, C₁ is smaller than 1.0 and C₂ is greater than 1.0; the numbers of output channels in the two convolutional layers comprised in the plurality of layers are set as N; and the kernel sizes in the two convolutional layers comprised in the two branches are 1×1 and 3×3 respectively, and the kernel sizes in the two convolutional layers comprised in the plurality of layers are set as 1×1 and 3×3 respectively.

10. The method of claim 1, wherein a configuration related to the plurality of branches in a basic block, a configuration related to the plurality of layers in a basic block, a configuration related to the activation layers in a basic block, and/or a configuration related to the convolutional layers in a basic block are determined based on at least one of the following:
decoded information of the video, or
at least one syntax element signaled from an encoder of the video to a decoder of the video.

11. The method of claim 1, wherein within a basic block,
activation layers comprised in the plurality of branches of the basic block are configured as non-linear functions, and activation layers comprised in the plurality of layers of the basic block are configured as identity mapping functions; and
convolutional layers comprised in the plurality of branches of the basic block are configured with different kernel sizes, and convolutional layers comprised in the plurality of layers of the basic block are configured with different kernel sizes; and
the numbers of output channels in convolutional layers comprised in the plurality of branches of a basic block are different, and the numbers of output channels in convolutional layers comprised in the plurality of layers of the basic block are the same.

12. The method of claim 11, wherein the activation layers comprised in the plurality of branches of the basic block are configured as at least one of the following: parametric rectified linear units (PReLUs), Leaky Rectified Linear Units (LReLUs), or Rectified Linear Units (ReLUs); and/or
wherein among the plurality of branches of the basic block, a kernel size in a first convolutional layer comprised in a first branch is smaller than a kernel size in a second convolutional layer comprised in a second branch, and a first number of output channels in the first convolutional layer is larger than a second number of output channels in the second convolutional layer, and among the plurality of layers of the basic block, a kernel size in a previous convolutional layer is smaller than a kernel size in a following convolutional layer; or
wherein among the plurality of branches of the basic block, a kernel size in the first convolutional layer comprised in the first branch is larger than a kernel size in the second convolutional layer comprised in the second branch, and the first number of output channels in the first convolutional layer is smaller than the second number of output channels in the second convolutional layer, and among the plurality of layers of the basic block, a kernel size in a previous convolutional layer is smaller than a kernel size in a following convolutional layer.

13. The method of claim 1, wherein the at least one basic block comprised in the NN model comprises at least one basic block of a first type and/or at least one basic block of a second type;
wherein a basic block of the first type having no skip connection to add an input to the basic block to the output of a last layer of the basic block; and
wherein a basic block of the second type has a skip connection to add an input to the basic block to the output of a last layer of the basic block.

14. The method of claim 1, wherein the NN model comprises a head part, a backbone part, and a tail part,
wherein the head part is configured for extracting features from an input to the NN model, the backbone part is configured for further feature mapping, and the tail part is configured for transforming output features of the backbone part into an output of the NN model.

15. The method of claim 14, wherein at least one of the head part, the backbone part, or the tail part each comprises a first number of basis blocks of the first type that are connected in series; or
wherein at least one of the head part, the backbone part, or the tail part each comprises a second number of basis blocks of the second type that are connected in series; or
wherein at least one of the head part, the backbone part, or the tail part each comprises a first number of basis blocks of the first type that are connected in series, following a second number of basis blocks of the second type that are connected in series; or
wherein at least one of the head part, the backbone part, or the tail part each comprises a second number of basis blocks of the second type that are connected in series, following a first number of basis blocks of the first type that are connected in series, or
wherein the head part comprises a second number of basis blocks of the second type that are connected in series, the backbone part comprises the second number of basis blocks of the second type that are connected in series, following a first number of basis blocks of the first type that are connected in series, and the tail part comprises a regular convolutional layer.

16. The method of claim 1, wherein integer operations are applied in the NN model; and
wherein no floating-point operations are applied in the NN model; and
wherein no division operations are applied in the NN model; and/or
wherein the integer operations applied in the NN model comprises at least one of the following: an adding operation, a multiplying operation, a shifting operation, a rounding operation, and a clipping operation.

17. The method of claim 1, wherein the conversion includes encoding the current video block into the bitstream, or
wherein the conversion includes decoding the current video block from the bitstream.

18. An apparatus for processing video data comprising a processor and a non-transitory memory with instructions thereon, wherein the instructions upon execution by the processor, cause the processor to perform acts comprising:
obtaining a neural network (NN) model for processing a video, the NN model comprising at least one basic block, wherein a basic block comprises:
a plurality of branches for parallel processing an input of the basic block, a branch comprising at least one convolutional layer and at least one activation layer, and
a plurality of layers for serial processing a combination of outputs of the plurality of branch, the plurality of layers comprising at least one convolutional layer and at least one activation layer; and
performing, according to the NN model, a conversion between a current video block of the video and a bitstream of the video.

19. A non-transitory computer-readable storage medium storing instructions that cause a processor to perform acts comprising:
obtaining a neural network (NN) model for processing a video, the NN model comprising at least one basic block, wherein a basic block comprises:
a plurality of branches for parallel processing an input of the basic block, a branch comprising at least one convolutional layer and at least one activation layer, and
a plurality of layers for serial processing a combination of outputs of the plurality of branch, the plurality of layers comprising at least one convolutional layer and at least one activation layer; and
performing, according to the NN model, a conversion between a current video block of the video and a bitstream of the video.

20. A non-transitory computer-readable recording medium storing a bitstream of a video which is generated by a method performed by a video processing apparatus, wherein the method comprises:
obtaining a neural network (NN) model for processing a video, the NN model comprising at least one basic block, wherein a basic block comprises:
a plurality of branches for parallel processing an input of the basic block, a branch comprising at least one convolutional layer and at least one activation layer, and
a plurality of layers for serial processing a combination of outputs of the plurality of branch, the plurality of layers comprising at least one convolutional layer and at least one activation layer; and
generating a bitstream of the video according to the NN model.
